(19) United States
(12) Patent Application Publication
(10) Pub. No.: US 2003/0099295 A1
(43) Pub. Date: May 29, 2003

(54) Method for fast motion estimation using bi-directional and symmetrical gradient schemes

(75) Inventors: Amir Averbuch, Jaffa (IL); Yossi Keller, Givat Shmuel (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: InfoWrap Inc.

(21) Appl. No.: 10/035,151

(22) Filed: Jan. 4, 2002

Related U.S. Application Data
(60) Provisional application No. 60/330,781, filed on Oct. 31, 2001.

(51) Int. Cl. H04N 7/12

(52) U.S. Cl. 375/240.16; 348/699

(57) ABSTRACT

A method for fast motion estimation determines the relative motion between a first and a second image by using either a bi-directional gradient method (BDGM) or a symmetric gradient method (SGM) approach. The global motion, defined by a plurality of parameters in which each parameter has an interval, is estimated by providing an initial estimate of two translation parameters each having an interval of values, dividing each interval into two non-equal (BDGM) or equal (SGM) sub-intervals, and using an iterative process starting with the initial estimate of the two equal sub-intervals. The iterative process calculates the optimal value (BDGM) or a center value (SGM) of the value interval of each parameter and yields a final parameters vector defining the global motion. The bi-directional and the symmetric gradient methods provide faster convergence and smaller linearization error, or convergence in cases where regular gradient methods do not converge.

### FIELD AND BACKGROUND OF THE INVENTION

Moving objects are often characterized by a coherent motion (rotation and translation) that is distinct from that of the background. This makes motion a very useful feature for segmenting video sequences. It can complement other features such as color, intensity, or edges that are commonly used for segmentation of still images.

We start by defining the term motion. We denote by I(x,y;k) the intensity or luminance of pixel (x,y) in frame k. Following the definitions in A. M. Tekalp, Ed., “Digital Video Processing”, Upper Saddle River, N.J., Prentice-Hall, 1995 (hereinafter TEK95), we have to distinguish between two-dimensional (2-D) and apparent motion. The projection of the three-dimensional (3-D) motion onto the image plane is referred to as 2-D motion. It is the true motion that we would like to automatically detect. On the other hand, apparent motion is what we perceive as motion and is induced by temporal changes in the image intensity I(x,y;k). Apparent motion can be characterized by a correspondence vector field or by an optical flow field. A correspondence vector describes the displacement of a pixel between two frames, whereas the optical flow (u,v) at pixel (x,y;k) refers to a velocity and is defined as

$$( u , v ) = ( \frac{\partial x}{\partial t} , \frac{\partial y}{\partial t} ) \qquad ( 1 )$$

The optical flow and correspondence vectors are related. From Eq. 1 it can also be seen that apparent motion is highly sensitive to noise, which can cause largely incorrect results. Further, moving objects or regions must contain sufficient texture to generate optical flow, because the luminance in the interior of moving regions with uniform intensity remains constant. Unfortunately, we can only observe apparent motion.

Motion Estimation

Besides the difficulties already mentioned, motion estimation algorithms have to solve the so-called occlusion and aperture problem, The occlusion problem refers to the fact that no correspondence vectors exist for covered and uncovered background. To illustrate the aperture problem, we fist introduce the optical flow constraint (OFC). It assumed that the intensity remains constant along the motion trajectory (TEK95), i.e.,

$$\begin{matrix}\frac{\partial }{\partial t} I ( w , y ; k ) = \frac{\partial I}{\partial x} \cdot \frac{\partial x}{\partial t} + \frac{\partial I}{\partial y} \cdot \frac{\partial y}{\partial t} + \frac{\partial I}{\partial t} \\ = ⟨ ∇ I , ( u , v ) ⟩ + \frac{\partial I}{\partial t} = 0\end{matrix} \qquad ( 2 )$$

where (.,.) denotes the vector inner product. The aperture problem states that the number of unknowns is larger than the number of observations. From the optical flow constraint (Eq. 2) it follows that only the flow component in the direction of the gradient, the so-called normal flow, can be estimated. The orthogonal component can take on any value without changing the inner product, and is therefore not defined. Thus, additional assumptions are necessary to obtain a unique solution. These usually impose some smoothness constraints on the optical flow field to achieve continuity.

There are two ways of describing motion fields:

1. Nonparametric representation. A dense field is estimated where each pixel is assigned a correspondence or flow vector. Then block matching is applied. The current frame is subdivided into blocks of equal size, and for each block the best match in the next (or previous) frame is computed. All pixels of a block are assumed to undergo the same translation, and are assigned the same correspondence vector. The selection of the block size is crucial. Block matching is unable to cope with rotations and deformations. Nevertheless, the simplicity and relative robustness of block matching makes it a popular technique. Nonparametric representations are not suitable for segmentation because an object moving in the 3-D space generates a spatially varying 2-D motion field even with the same region, except for the simple case of pure translation. This is the reason why parametric models are commonly used in segmentation algorithms. However, dense field estimation is often the first step in calculating the model parameters.

2. Parametric models require a segmentation of the scene, which is our ultimate goal, and describe the motion of each region by a set of a few parameters. The motion vectors can then be synthesized from these model parameters. A parametric representation is more compact than a dense field description and less sensitive to noise, because many pixels are treated jointly to estimate a few parameters.

In order to derive a model or transformation that describes the motion of pixels between successive frames, assumptions on the scene and objects have to be made. Let (X,Y,Z) and (X′, Y′, Z′) denote the 3-D coordinates of an object point in frame k and k+1, respectively. The corresponding image plane coordinates are (x,y) and (x′, y′). If a 3-D object undergoes translation, rotation and linear deformation, the 3-D displacement of a point on the object is given in (G. Wolberg, “Digital Image Warping”, IEEE, 1984, hereinafter WOL84)

$$( \begin{matrix}{X}^{′} \\ {Y}^{′} \\ {Z}^{′}\end{matrix} ) = ( \begin{matrix}{s}_{11} & {s}_{12} & {s}_{13} \\ {s}_{21} & {s}_{22} & {s}_{23} \\ {s}_{31} & {s}_{32} & {s}_{33}\end{matrix} ) ( \begin{matrix}X \\ Y \\ Z\end{matrix} ) + ( \begin{matrix}{t}_{1} \\ {t}_{2} \\ {t}_{3}\end{matrix} ) \qquad ( 3 )$$

It is very common to model 3-D objects by (piecewise) planar patches whose points satisfy

aX+bY+cZ=1 (4)

If such a planar object is moving according to Eq. 3, one obtains the “affine motion model” under orthographic projection and the “eight-parameter model” under perspective projection.

The 3-D coordinates are related to the image plane coordinates under the orthographic (parallel) projection by

(x,y)=(X,Y) and (x,y)=(x′,Y′)=(X′,Y′). (5)

This projection is computationally efficient and is good approximation if the distance between the objects and the camera is large compared to the depth of the objects. From Eqs. 3-5, it follows that

x′=a₁x+a₂y+a₃

y′=a₄x₅y+a₆ (6)

which is known as the affine model. In the case of the more realistic perspective (central) projection, one gets

$$( x , y ) = ( \frac{X}{Z} , \frac{Y}{Z} ) and ( {x}^{′} , {y}^{′} ) = ( \frac{{X}^{′}}{{Z}^{′}} , \frac{{Y}^{′}}{{Z}^{′}} ) \qquad ( 7 )$$

Together with Eqs. 3 and 4, this results in the eight-parameter model

$${x}^{′} = \frac{{a}_{1} x + {a}_{2} y + {a}_{3}}{{a}_{7} x + {a}_{8} y + 1} \\ {y}^{′} = \frac{{a}_{4} x + {a}_{5} y + {a}_{6}}{{a}_{7} x + {a}_{8} y + 1} \qquad ( 8 )$$

Both the affine and the eight-parameter models are very popular, but many other transformations exist depending on the assumption made.

Parametric models describe each region by one set of parameters that is either estimated by fitting a model (in the least squares sense) to a dense motion field obtained by a nonparametric method, or directly from the luminance signal I(x,y;k) as in M. Hotter and R. Thoma, “Image segmentation based on object oriented mapping parameter estimation”a, Signal Processing, vol. 15, no. 3, pp. 315-334, 1988 (hereinafter HOT88), and in H. G. Musmann, M. Hotter, and J. Ostermann, “Object-oriented analysis-synthesis coding of moving images”, Signal Processing: Image Commun., vol. 1, pp. 117-138, 1989 (hereinafter MUS89). Although parametric representations are less noise sensitive, they still suffer from the intrinsic problems of motion estimation. It should be noticed that one has to be careful when interpreting an estimated flow field. Most likely, it is necessary to include additional information such as color or intensity to accurately and reliably detect boundaries of moving objects.

Image registration plays a vital role in many image processing applications such as video compression (TEK95; F. Dufaux and J. Konrad, “Efficient, Robust, and Fast Global Motion Estimation for Video Coding”, IEEE Transactions on Image Processing, vol. 9, no. 3, pp. 497-501, March 2000 (hereinafter DU00)), video enhancement (M. Irani and S. Peleg, “Motion Analysis for Image Enhancement: Resolution, Occlusion, and Transparency”, Journal of Visual Communication and Image Representation, Vol. 4, No. 4, pp. 324-335, December 1993 (hereinafter IRA93)) and scene representation (S. Man and R. W. Picard, “Virtual Bellows: constructing high quality stills from video”, Proc. IEEE Int. Conf. Image Processing Austin, Tex. Nov. 13-16, 1994 (hereinafter MAN94), R. Szeliski, “Image Mosaicing for Tele-Reality Applications”, CRL 94/2, May 1994 (hereinafter SZE94), and M. Irani, P. Anandan, and S. Hsu, “Mosaic based representations of video sequences and their applications”, International Conference on Computer Vision, pages 605-611, 1995 (hereinafter IRA95)). It has drawn a significant research attention. A comprehensive comparative survey by L. Barron, D. J. Fleet and S. S. Beauchemin, “Performance of Optical flow Techniques”, Int. J. Computational Vision, Vol. 12, pp. 43-77, 1994 (hereinafter BAR94) found the family of gradient-based motion (GM) estimation methods, originally proposed by B. K. P. Horn and B. G. Schunck, “Determining Optical Flow”, Artificial Inteligence, vol. 17, pp. 185-203, 1981 (hereinafter HOR8l), to perform especially well. The purpose of the GM algorithm is to estimate the parameters vector P associated with the parametric image registration problem: starting from pure global translation (2 parameters), image plane rotation (4 parameters), 2-D affine (6 parameters), and pseudo-projective (8-parameter flow).

These models have been used extensively and are estimated directly from image spatio-temporal derivatives using coarse-to-fine estimation via Gaussian pyramids (multi-scale). These methods search for the best parametric geometric transform that minimizes the square of change between image intensities (SSD) over the whole image. An updated comprehensive description of these methods can be found in (M. Irani and P. Anandan, “All About Direct Methods”, ftp://ftp.robots.ox.ac.uk/pub/outgoing/phst/summary.ps.gz (hereinafter IRAftp)).

Let I₁(x,y) and I₂(x,y) be two images 20 and 22 respectively that have some common overlap as shown by a shaded area 24 in FIG. 1. Then each pixel in their common support (area 24) satisfies:

I₁(x,y)=I₂(\tilde{x}(x,y,P),\tilde{y}(x,y,P)) (9)

where P is a parameters vector having a structure that depends on the type of the estimated motion model. Gathering and solving all the equations associated with pixels in the mutual support (area 24) (P is assumed to be constant over the whole mutual area 24, estimates the global motion between the images (SZE94), thus gaining robustness (in the estimated parameters of the global motion estimation) due to very highly over-constrained linear systems (each pixel contributes a linear constraint). Gathering the equations related to small image patches estimates local motion (B. Lucas and T. Kanade, “ An iterative image registration technique with an application to stereo vision”, in Proc. DARPA, Image Understanding Workshop, pp. 121-130, 1981 (hereinafter LUC81)). Equation 9 is preferably solved using non-linear iterative optimization techniques such as Gauss-Newton (W. H. Press, B. P. Flannery, S. A. Teukolsky, and W. T. Vetterling, “Numerical Recipes in C: The Art of Scientific Computing”, Cambridge Univ. Press, 1988 (hereinafter PRE88)) and Levenberg-Marquardt (LM) (SZE94) described in section 4.1. A critical 15 implementation issue concerning the GM is the convergence range and the rate of convergence while estimating large image motions: as the estimated motion becomes larger, the convergence rate decreases, and the GM may diverge to a local minima. A possible solution is to bootstrap the motion estimation process with a different motion estimation algorithm (C. D. Kuglin and D. C. Hines. “The phase correlation image alignment method”, IEEE Conference on Cybernetics and Society, pp. 163-165, September 1975 (hereinafter KUG75), and DUF00), which is robust to large motions.

Gradient Method Based Motion Estimation

The GM methodology (IRAftp) estimates the motion parameters vector P by minimizing the intensity discrepancies between the images I₁(x,y) and I₂(x,y) described in FIG. 1

$${\underline{P}}^{*} = arg {min}_{\underline{P}} \{ {\sum }_{( {x}_{1} , {y}_{1} ) ∈ s} ( {I}_{1} ( {x}_{i}^{( 1 )} , {y}_{i}^{( 1 )} ) - {{I}_{2} ( f ( {x}_{i}^{( 1 )} , {y}_{i}^{( 1 )} , \underline{P} ) , g ( {x}_{i}^{( 1 )} , {y}_{i}^{( 1 )} , \underline{P} ) )}^{2} ) \} \qquad ( 10 )$$

where

xᵢ⁽²⁾=f(xᵢ⁽¹⁾,yᵢ⁽¹⁾,P)

yᵢ⁽²⁾=g(xᵢ⁽¹⁾,yᵢ⁽¹⁾,P) (11)

and S (in Eq. 10) is the set of coordinates of pixels that are common to I₁ and I₁₂ in I₁ coordinates.

The formulation of MAN94 and SZE94 is followed by solving Eq. 10 using non-linear iterative optimization techniques such as Gauss-Newton and Levenberg-Marquardt, cited above. The basic GM formulation and the iterative refinement stage, as well as their embedding in a multi-resolution scheme are described next.

Basic GM Formulation

The non-linear optimization of Eq. 10, is conducted via a linearization procedure, which is based on a pixel-wise, first order Taylor expansion of I₁ in terms of I_{12,} as a function of the parameters vector P:

$${I}_{1} ( {x}_{i}^{( 1 )} , {y}_{i}^{( 1 )} ) = {I}_{2} ( {x}_{i}^{( 2 )} , {y}_{i}^{( 2 )} ) + {\sum }_{{P}_{i} ∈ \underline{P}} \frac{\partial {I}_{2} ( {x}_{i}^{( 2 )} , {y}_{i}^{( 2 )} )}{\partial {P}_{i}} {P}_{i} \qquad ( 12 )$$

where

$$\frac{\partial {I}_{2} ( {x}_{i}^{( 2 )} , {y}_{i}^{( 2 )} )}{\partial {P}_{i}}$$

is the partial spatial derivative, (xᵢ⁽¹⁾,yᵢ⁽¹⁾) and (xᵢ⁽²⁾,yᵢ⁽²⁾) are the i^{th} common pixel in I₁ and I₂, respectively. By gathering the pixel-wise equations, a system

HP=Iₜ (13)

is formulated, where

$$\begin{matrix}{{H}_{\underline{\_}}}_{i , j} = \frac{\partial {I}_{2} ( {x}_{i}^{( 2 )} , {y}_{i}^{( 2 )} )}{\partial {P}_{j}} \\ = \frac{\partial {I}_{2} ( {x}_{i}^{( 2 )} , {y}_{i}^{( 2 )} )}{\partial {x}_{2}} \frac{\partial f ( {x}_{i}^{( 1 )} , {y}_{i}^{( 1 )} , \underline{P} )}{\partial {P}_{j}} + \\ \frac{\partial {I}_{2} ( {x}_{i}^{( 2 )} , {y}_{i}^{( 2 )} )}{\partial {y}_{2}} \frac{\partial g ( {x}_{i}^{( 1 )} , {y}_{i}^{( 1 )} , \underline{P} )}{\partial {P}_{j}}\end{matrix} \qquad ( {13}^{′} )$$

and

Iₜ_{ᵢ}=I₁(xᵢ⁽¹⁾,yᵢ⁽¹⁾)−I₂(xᵢ⁽²⁾,yᵢ⁽²⁾). (14)

Equation 13 is formulated using the chain rule. Equation 13 can be solved using regular least square (PRE88):

P=(H^{t}H)⁻¹H^{t}Iₜ (15)

where H^{t} is the transpose of H. The expressions for H^{t}H and H^{t}Iₜ can be derived analytically by direct calculation:

$$\begin{matrix}{( {{H}_{\underline{\_}}}^{t} {H}_{\underline{\_}} )}_{k , j} = {\sum }_{i} \frac{\partial {I}_{2} ( {x}_{i}^{( 2 )} , {y}_{i}^{( 2 )} )}{\partial {P}_{k}} \frac{\partial {I}_{2} ( {x}_{i}^{( 2 )} , {y}_{i}^{( 2 )} )}{\partial {P}_{j}} & ( 16 ) \\ {( {{H}_{\underline{\_}}}^{t} {\underline{{I}_{t}}}_{i} )}_{k} = {\sum }_{i} \frac{\partial {I}_{2} ( {x}_{i}^{( 2 )} , {y}_{i}^{( 2 )} )}{\partial {P}_{k}} {\underline{{I}_{t}}}_{i} & ( 17 )\end{matrix}$$

Algorithm Flow

FIG. 2 shows a flow chart of the basic steps in the implementation of the GM algorithm. The flow chart includes a single iteration module or “phase” 30 reflecting the basic GM iteration, comprised of a computation step 32 and a solution step 34. The basic GM iteration is typically as follows:

1. The matrix H^{t}H and vector H^{t}Iₜ are computed in step 32 using Eqs. 16 and 17, respectively.

2. Eq. 15 is solved in step 34 using singular value decomposition (PRE88).

3. The GM returns P as its output (result) in an output step 38.

The single iteration phase is incorporated in an iterative solution, given below.

Iterative Solution of the GM

Denote:

P₀—an initial estimated solution of Eq. 10 given as input, such that Warp (I₂, PO)≈I₁

Pₙ—the estimated solution after n=1, . . . iterations

Then, the n^{th} iteration of the motion estimation algorithm becomes (FIG. 2):

1. The input image I₂ is warped towards I₁, in a warping step 36 using the current estimate Pₙ and it is stored in Ĩ₂ for n>0. For n=0, P₀ is given as an input.

2. I₁ and Ĩ₂ are used as input images to the procedure described in the basic GM formulation section above.

3. The result of the previous—- ΔP, is used to update the solution in step 38:

Pₙ₊₁=ΔP+Pₙ

n≧0

4. Use a checking step 40 and go back to step 1 above until one of the following stopping criteria is met:

a. At most nₘₐₓ iterations are performed

or

b. The process is stopped if the translation parameters within the updated term ΔP reach a predetermined threshold.

Gradient Methods With Multi-Scale Scheme

In order to improve the robustness and reduce the complexity of the algorithm, the iterative process is embedded in a coarse-to-fine multi-scale formulation. The robustness analysis is given in the Multiresolution GM scheme section below. The coarse-to-fine formulation is described next. A thorough description can also be found in MAN94:

1. The input images I₁ and I₂ are smoothed. Experience shows that a separable averaging filter is suitable for this task.

2. The input images I₁ and I₂ are down-sampled through multi-scale decomposition, until a minimal size of their mutual area is reached. The minimal mutual area size depends upon the estimated motion model, while the resolution step depends upon the motion estimation accuracy at each resolution level.

3. Starting with the coarsest scale, the initial estimate P₀ is used to bootstrap the iterative refinement algorithm described in the iterative solution of the gradient methods section

4. The result of the iterative refinement from coarse-to-fine (step 2) is recursively repeated until the original image size is reached.

Convergence Analysis of Gradient Methods

In order to analyze the convergence properties of the GM algorithm, the convergence properties of the general Gauss-Newton algorithm are examined next.

General Convergence Analysis of the Gauss-Newton Algorithm

The convergence of the Gauss-Newton algorithm can be divided into two distinct phases:

∥εₖ₊₁∥≦C₁∥εₖ∥+C₂∥ξₖ∥² (18)

where:

$${C}_{1} = ‖ {[ A ( {\underline{x}}_{k} ) {A}^{T} ( {\underline{x}}_{k} ) ]}^{- 1} {\sum }_{n = 1}^{m} \frac{\partial {r}_{n}^{2} ( {x}_{k} )}{\partial x} {r}_{n} ( {\underline{x}}_{k} ) ‖ \\ {C}_{2} = ‖ {[ A ( {\underline{x}}_{k} ) {A}^{T} ( {\underline{x}}_{k} ) ]}^{- 1} ‖ \qquad ( 19 )$$

εₖis the parameters estimation error after iteration k

rₙ(xₖ) is the error associated with the n^{th} equation at iteration k

A(xₖ) is the Jacobian matrix at iteration k.

By rearranging the GM formulations developed in the previous sections, these expressions are interpreted in the context of the GM formulation. C₁ and C₂ will be denoted C₁^{GM} and C₂^{GM}, respectively.

rₙ(xₖ)=I₁(xᵢ⁽¹⁾,yᵢ⁽¹⁰)−I₂(f(xᵢ⁽¹⁾,yᵢ⁽¹⁰,P),g(xᵢ⁽¹⁾,yᵢ⁽¹⁾,P) (20)

where the parameters vector x identifies with P:

$${A}_{i , k} = \frac{\partial {r}_{n} ( {\underline{x}}_{k} )}{\partial {x}_{k}} = \frac{\partial {I}_{2} ( {x}_{i}^{( 2 )} , {y}_{i}^{( 2 )} )}{\partial {P}_{k}} \qquad ( 21 )$$

and the equation index n is identified with the GM index i, since there is one equation per common pixel. Thus, A(xₖ) is identified with the matrix H defined in Eq. 13 and the second derivative

$$\frac{{\partial }^{2} {r}_{n} ( {\underline{x}}_{k} )}{\partial {x}_{k}^{2}}$$

is given by:

$$\frac{{\partial }^{2} {r}_{n} ( {\underline{x}}_{k} )}{\partial {x}_{k}^{2}} = \frac{{\partial }^{2} {I}_{2} ( {x}_{i}^{( 2 )} , {y}_{i}^{( 2 )} )}{\partial {P}_{k}^{2}} . \qquad ( 22 )$$

Therefore, we have

$$\begin{matrix}{C}_{1}^{GM} = ‖ {[ \frac{\partial {I}_{2}}{\partial \underline{P}} \frac{\partial {I}_{2}^{T}}{\partial \underline{P}} ]}^{- 1} {\sum }_{n = 1}^{m} \frac{{\partial }^{2} {I}_{2} ( {x}_{i}^{( 2 )} , {y}_{i}^{( 2 )} )}{\partial {P}_{k}^{2}} {r}_{n} ( {\underline{x}}_{k} ) ‖ & ( 23 ) \\ {C}_{2}^{GM} = ‖ {[ \frac{\partial {I}_{2}}{\partial \underline{P}} \frac{\partial {I}_{2}^{T}}{\partial \underline{P}} ]}^{- 1} ‖ . & ( 24 )\end{matrix}$$

The basic GM equation (Eq. 12) is solved by the Gauss-Newton algorithm using the LS formulation given in Eq. 20. The error associated with each equation is the truncation error of the first order Taylor expansion (PRE88):

$${ϵ}_{GM} = ϵ ( {x}_{i}^{( 2 )} , {y}_{i}^{( 2 )} , \underline{P} ) = \frac{1}{2} {\sum }_{{P}_{i} ∈ \underline{P}} \frac{{\partial }^{2} {I}_{2} ( {x}_{i}^{( 2 )} , {y}_{i}^{( 2 )} )}{\partial {P}_{i}^{2}} {( {P}_{i} - {P}_{i}^{*} )}^{2} \qquad ( 25 )$$

where P^{*} is the optimal solution (parameters vector) for the optimization problem.

In the GM setup, the sum of second partial derivatives

$$\frac{{\partial }^{2} {I}_{2} ( {x}_{i}^{( 2 )} , {y}_{i}^{( 2 )} )}{\partial {P}_{i}^{2}}$$

does not strongly depend on the motion parameters vector P, and the magnitude of C₁^{GM} is dominated by ∥P−P∥. Hence, for large motions ∥P−P^{*}∥ [symbol] 0, C₁^{GM} [symbol] 0 and the error decay rate becomes linear rather than quadratic. Therefore, the convergence of the GM algorithm can be divided into two phases:

Initialization phase: in the first iterations ∥P−P^{*}∥ [symbol] 0, and C₁^{GM} [symbol] 0, therefore the convergence rate is linear.

Convergence phase: near the solution ∥P−P^{*}∥→0, and C₁^{GM}→0, and the convergence rate is quadratic according to C₂^{GM}, where C₂^{GM} is a function of the image properties.

An example of the verification as described above is demonstrated by registering the two images shown in FIG. 3. FIG. 3 shows a test of the Gauss-Newton convergence: (a) is an original “Airfield” image, and (b) is the “Airfield” image rotated by 30° using bilinear interpolation. An X mark indicates the initial estimate of the motion given as translation. The registration results are presented in FIG. 4, which indicates that the convergence process is divided into two phases: the first is related to a large motion estimation characterized by a low convergence rate m_{(C1)}, while the second is related to a small motion estimation characterized by a high convergence rate m_{(C2)}. The low-rate convergence corresponds to the linear convergence from n=0 to about n=170, and the high rate convergence corresponds to the quadratic convergence phase encountered after a cross-over point located at about n=170.

Multi-Resolution GM Scheme

The relationship between the pyramidal GM scheme and the convergence properties of the GM was studied by P. J. Burt, R. Hingorani and R J Kolczynski, “Mechanisms for isolating component patterns in the sequential analysis of multiple motion”, IEEE Workshop on Visual Motion, Princeton, N.J. Oct. 1991 (hereinafter BUR91) in the frequency domain for pure translations. By examining the error associated with the translation coefficients, the multi-scale scheme was proved to decrease the error term in Eq. 25 and improve the convergence rate.

Denote by εₜᵣₐₙₛ(s)—the error associated with the translation parameters (dxₛ,dyₛ) at a resolution scale s:

$$\underline{{ϵ}_{trans}} ( s ) = [ \begin{matrix}ⅆ {x}_{s} - ⅆ {x}_{s}^{*} \\ ⅆ {y}_{s} - ⅆ {y}_{s}^{*}\end{matrix} ] \qquad ( 26 )$$

where dxₛ^{*} and dyₛ^{*} are the optimal values of the translation parameters in scale s. Then, by scaling down the images from scale s₁ to scale s₂(s₂>s₁) one gets:

$$ⅆ {x}_{{s}_{2}} = ⅆ {x}_{{s}_{1}} \cdot \frac{{s}_{1}}{{s}_{2}} \\ ⅆ {y}_{{s}_{2}} = ⅆ {y}_{{s}_{1}} \cdot \frac{{s}_{1}}{{s}_{2}} \qquad ( 27 )$$

and the associated error becomes

$${\underline{{ϵ}_{trans}} ( {s}_{2} )}^{2} = {( \begin{matrix}ⅆ {x}_{{s}_{2}} - ⅆ {x}_{{s}_{2}}^{*} \\ ⅆ {y}_{{s}_{2}} - ⅆ {y}_{{s}_{2}}^{*}\end{matrix} )}^{2} = {( \begin{matrix}ⅆ {x}_{{s}_{1}} \cdot \frac{{s}_{1}}{{s}_{2}} - ⅆ {x}_{{s}_{2}}^{*} \cdot \frac{{s}_{1}}{{s}_{2}} \\ ⅆ {y}_{{s}_{1}} \cdot \frac{{s}_{1}}{{s}_{2}} - ⅆ {y}_{{s}_{2}}^{*} \cdot \frac{{s}_{1}}{{s}_{2}}\end{matrix} )}^{2} = {\underline{{ϵ}_{trans}} ( {s}_{1} )}^{2} {\underbrace{( \frac{{s}_{1}}{{s}_{2}} )}_{< 1}}^{2} . \qquad ( 28 )$$

Hence, the error associated with the translation error is decreased by a factor of s₁/s₂<1. Inserting Eq. 28 into Eq. 25 we get:

$$\begin{matrix}{ϵ}_{GM} ( {x}_{i}^{( 2 )} , {y}_{i}^{( 2 )} , [ dx , dy ] , {s}_{2} ) = \frac{1}{2} {\sum }_{{P}_{i} ∈ [ dx , dy ]} \frac{{\partial }^{2} {I}_{2} ( {x}_{i}^{( 2 )} , {y}_{i}^{( 2 )} )}{\partial {P}_{i}^{2}} {\underline{{ϵ}_{trans}} ( {s}_{2} )}^{2} \\ = \frac{1}{2} {\sum }_{{P}_{i} ∈ [ dx , dy ]} \frac{{\partial }^{2} {I}_{2} ( {x}_{i}^{( 2 )} , {y}_{i}^{( 2 )} )}{\partial {P}_{i}^{2}} ( {\underline{{ϵ}_{trans}} ( {s}_{1} )}^{2} {( \frac{{s}_{1}}{{s}_{2}} )}^{2} ) \\ = {ϵ}_{GM} ( {x}_{i}^{( 2 )} , {y}_{i}^{( 2 )} , [ dx , dy ] , {s}_{1} ) \underbrace{{( \frac{{s}_{1}}{{s}_{2}} )}^{2}}_{< 1}\end{matrix} \qquad ( 29 )$$

Hence, for a dyadic pyramid, the truncation error of the Taylor approximation, related to the translation parameters (Eq. 29) is decreased by a factor of 4 in each increase of the pyramid's scale. Note that the error associated with motion parameters such as scale and shear, which are scale-invariant, is not reduced. Hence, multi-resolution schemes do not improve the convergence properties when the motion is dominated by scale and shear. This method can achieve higher convergence rate if instead of dyadic division, we use bigger scale factors.

Dominant Motion Locking

BUR91 used a frequency analysis to show that the coarse-to-fine refinement process allows the GM to lock on a single dominant motion even when multiple motions are present. This property is essential for most applications, which are based on image registration (SZE94, IRA93 and IRA95). The method presented above is utilized herein to provide an optimization-based analysis of this property, by studying the error associated with objects that perform dominant and non-dominant motions. This analysis extends the results of BUR91 by being applicable to general motion models—parametric and non-parametric.

Notation:

S

The set of pixels that are common to I₁ and I₂

S_{Dom}

A subset of S. This set of pixels that are common to I₁ and ₂, whose motion is the dominant motion, was defined above

S_{NonD}

A subset of S. This set of pixels that are common to I₁ and I₂, whose motion is not the dominant motion

By permuting the rows of Eq. 13 according to the i^{th} pixel's relation, which belongs to either S_{Dom} or S_{NonD}, one gets:

$${\tilde{H}}_{\underline{\_}} \underline{P} = [ \begin{matrix}{{H}_{\underline{\_}}}_{Dom} \\ {{H}_{\underline{\_}}}_{NonD}\end{matrix} ] \underline{P} = [ \begin{matrix}{\underline{I}}_{t}^{Dom} \\ {\underline{I}}_{t}^{NonD}\end{matrix} ] = {\tilde{\underline{I}}}_{t} \qquad ( 30 )$$

where

\tilde{H}_{Dom}P=Iₜ^{Dom} (31)

are the equations related to dominant motion, and

\tilde{H}_{NonD}P=Iₜ^{NonD} (32)

are the equations related to non-dominant motion. As the GM algorithm converges to the dominant motion, the term Iₜ^{NonD} becomes a difference of uncorrelated pixels. Therefore, by assuming image isotropy, Iₜ^{NonD} can be modeled as uniformly distributed random variable with zero mean

E{Iₜ^{NonD}}=0. (33)

This is a landslide type phenomenon: as the iterative solution Pₙ gets closer to the dominant motion's true parameters P^{Dom},the non-dominant pixels become more and more uncorrelated. Inserting Eq. 33 into Eq. 15:

$$\begin{matrix}\underline{E \{ Δ P \}} = E \{ {( {{\tilde{H}}_{\underline{\_}}}^{t} {\tilde{H}}_{\underline{\_}} )}^{- 1} {{\tilde{H}}_{\underline{\_}}}^{t} \underline{{\tilde{I}}_{t}} \} \\ = E \{ {( {{\tilde{H}}_{\underline{\_}}}^{t} {\tilde{H}}_{\underline{\_}} )}^{- 1} {{\tilde{H}}_{\underline{\_}}}^{t} [ \frac{{I}_{t}^{Dom}}{\underline{0}} ] \} + E \underbrace{\{ {( {{\tilde{H}}_{\underline{\_}}}^{t} {\tilde{H}}_{\underline{\_}} )}^{- 1} {{\tilde{H}}_{\underline{\_}}}^{t} [ \begin{matrix}\underline{0} \\ \underline{{I}_{t}^{NonD}}\end{matrix} ] \}}_{= 0} \\ = {\underline{P}}^{Dom}\end{matrix} \qquad ( 34 )$$

Thus, the non-dominant outliers are automatically rejected. The conclusion is that the GM is a non-biased estimator of the dominant motion parameters P^{Dom}, where the variance of the estimation Var(P^{Dom}) depends on the ratio between dominant and non-dominant pixels.

In order to better understand the method of the present invention, reference is first made to the general steps of the GM as described in FIG. 5. An input step 100 to the algorithm includes providing two images I₁(s), I₂(s) (where s is the index of the current iteration of the algorithm) and an initial estimate of a geometric warping T, such that T(I₂)≈I₁. When s=0, I₁(0) and I₂(0) are the input images to the process. The images are typically given as 2-D arrays, and the warping T is typically given as a parameters vector P. The input images are smoothed in step 100, typically using a separable averaging filter (application of an one-dimensional filter in the x direction and then in the y direction) whose 1-D component is [1/n, . . . ,1/n], where n is the width of the filter. The resulting output images I₁(s) and I₂(s)(s=0) of step 100 are of the same dimension as the source images. The output images are fed to a downscaling step 102. In step 102 the images are downscaled by typically a factor of 3, using for example the following process: the images are smoothed typically using a separable kernel [⅓, ⅓, ⅓] and the parameters vector P is downscaled using the following equation:

$${P ( s + 1 )}_{\underline{\_}} = ( \begin{matrix}{S}_{x} & 0 & 0 \\ 0 & {S}_{y} & 0 \\ 0 & 0 & 1\end{matrix} ) {P ( s )}_{\underline{\_}} = ( \begin{matrix}{S}_{x} & 0 & 0 \\ 0 & {S}_{y} & 0 \\ 0 & 0 & 1\end{matrix} ) ( \begin{matrix}{P}_{11} & {P}_{12} & {P}_{13} \\ {P}_{21} & {P}_{22} & {P}_{23} \\ {P}_{31} & {P}_{32} & {P}_{33}\end{matrix} ) \qquad ( 35 )$$

The resulting output images are denoted I₁(s+1), I₂(s+1) and P(s+1)

The downscaled image size is checked in a checking step 104. If the image dimensions are not too small (minimal dimension of typically 20 pixels) the images and the parameters vector are downscaled again (return to step 102). If the images are too small, the algorithm proceeds to an up-scaling step 106 in which higher resolution scale images I₁(s+1) and I₂(s+1) and an initial guess Pₙ(s+1) are output as I₁l(s), I₂(s) and Phd n, where n is an index set initially to zero.

In a warping step 108, I₂(s) is warped towards I₁(s) using Pₙ. The result (output) is I₂^{warp}. Next, in a stopping step 110, two stopping criteria are checked. If either one of them is satisfied, the algorithm proceeds to a step 112, which checks the current resolution scale s: if this is the base resolution (s=0), the execution of the algorithm is terminated. If not, the algorithm returns to 106. If neither of the stopping criteria in step 110 is met, the matrix H^{t}H and₁₃vector H^{t}Iₜ are next calculated in a calculation step 114 using the following equations:

$$\begin{matrix}{( {H}^{T} H )}_{i , j} = \frac{1}{2} {\sum }_{k = 1}^{m} \frac{\partial {I}_{2}^{warp} ( k )}{\partial {p}_{i}} \frac{\partial {I}_{2}^{warp} ( k )}{\partial {p}_{j}} & ( 36 ) \\ {( {{H}_{\underline{\_}}}^{T} {\underline{I}}_{t} )}_{k} - {\sum }_{j = 1}^{m} ( {I}_{1}^{warp} ( k ) - {I}_{2}^{warp} ( k ) ) g \frac{\partial {I}_{2}^{warp} ( k )}{\partial {p}_{j}} & ( 37 )\end{matrix}$$

where I₂^{Warp}(k) is the k^{th} pixel common to I₂^{warp} and I₁(s). The outputs H^{t}H and H^{t}Iₜ are then input to the equation (H^{t}H)ΔP=H^{t}Iₜ, which is solved in a solution step 116, and the result ΔP is used to update the estimate of the motion parameters vector Pₙ₊₁ in an updating step 118. The vector Pₙ₊₁ is the sought after parameters information.

Major disadvantages of the basic GM in all its forms include the facts that it takes too long, consumes a lot of memory, and, in many cases, it does not converge. Therefore, the basic GM is not useful for practical video processing. Since GM is a fundamental key component in any video compression schemes, its poor performance prevents its use in video applications when computation speed is critical.

There is thus a widely recognized need for, and it would be highly advantageous to have, a method for fast motion estimation that does not suffer from the disadvantages of the basic GM listed above, and would therefore be useful in video applications.

### SUMMARY OF THE INVENTION

The method of the present invention, as embodied by the bi-directional gradient method (BDGM) algorithm and the symmetric gradient method (SGM) algorithm represents a significant improvement over the Gradient Methods (GM) algorithm, which is considered to be the state-of-the-art algorithm for image registration, being able to estimate complicated motions at high sub-pixel accuracy. The BDGM provides a mechanism in which the algorithm finds the optimal location (in the sense that the errors of the calculated parameters are minimal) in the parameter space P. while the SGM provides a mathematical formulation, which is symmetric regarding I₁ and I₂. Both approaches allow better convergence rates and a significantly improved convergence range, while using the same order of computational complexity. The BDGM and SGM are suited for video compression and creation of mosaics in video coding applications, such as the one defined by the MPEG4 video compression standard. As with the GM algorithm, the BDGM and SGM algorithms estimate the parameters vector P associated with the parametric image registration problem, which consists of estimating the following: pure global translation (2 parameters), image plane rotation (4 parameters), 2-D affine (6 parameters), and pseudo-projective (8-parameter flow). However, in contrast with the GM, the BDGM disclosed in the present invention estimates the parameters vector P by approaching a location in the range of each parameter which minimizes the error of the calculated parameters, while the SGM estimates symmetrically the center value of the value range of each parameter. A value range is referred to hereafter as an “interval”. This is an essential, innovative feature of the present invention that results in the superior convergence properties of the BDGM and SGM over GM in various motion estimation applications.

According to the present invention there is provided a method for fast global motion estimation, the global motion defined by a plurality of parameters in which each parameter has an interval, the method comprising providing a first and a second image, providing an initial estimate of each of two translation parameters, and determining the relative global motion between the first and second images using a symmetric gradient approach in an iterative process starting with the initial estimates of the two translation parameters, whereby the symmetric gradient approach provides the center of each the parameter interval and results in improved global motion estimation convergence properties.

According to preferred features in the symmetric gradient method of the present invention, the step of providing an initial estimate of each of two translation parameters includes providing an initial interval for each translation parameter and dividing each translation parameter initial interval into two equal sub-intervals, and the step of determining the relative global motion between the first and second images using a symmetric gradient approach includes providing a basic SGM formulation that includes the sub-intervals, running in each iteration a point-wise linearization procedure on the basic SGM formulation, and deriving in each iteration a symmetric linearization error based on the linearization procedure.

According to the present invention there is provided a method for fast global motion estimation, the global motion defined by a plurality of parameters in which each parameter has an interval, the method comprising providing a first and a second image, providing an initial estimate of each of two translation parameters, and determining the relative global motion between the first and second images using a bi-directional gradient approach in an iterative process starting with the initial estimates of the two translation parameters, whereby the bi-directional gradient approach provides the optimal location of each parameter interval, and results in improved global motion estimation convergence properties.

According to preferred features in the bi-directional gradient method of the present invention, the step of providing an initial estimate of each of two translation parameters includes providing an initial interval for each translation parameter and dividing each translation parameter initial interval into twosub-intervals, and the step of determining the relative global motion between the first and second images using a bi-directional gradient approach includes providing a basic BDGM formulation that includes the sub-intervals, running in each iteration a point-wise linearization procedure on the basic BDGM formulation, and deriving in each iteration a bi-directional linearization error based on the linearization procedure.

The symmetric and bi-directional gradient approaches provide improved convergence properties to the motion estimation. The improved convergence properties include faster convergence than GM, or convergence in cases where the GM algorithms do not converge.

### BRIEF DESCRIPTION OF THE DRAWINGS

The invention is herein described, by way of example only, with reference to the accompanying drawings, wherein:

FIG. 1 shows an image translation, in which two images have a common support area;

FIG. 2 shows a block diagram of the basic and iterative GM formulations. For n=0, P₀ is given as an initial guess and ΔP is the iterative update after each iteration;

FIG. 3 shows X marks after the application of the Gauss-Newton convergence in a typical GM algorithm on an original and a rotated image;

FIG. 4 shows the two phases of a typical GM convergence process;

FIG. 5 shows a detailed block diagram of a typical gradient based motion estimation (GM) algorithm;

FIG. 6 shows graphically an 1-D illustration of a) basic GM techniques, b) the SGM technique, and c) the BDGM technique;

FIG. 7 shows block diagrams of replacement modules: a) SGM, and b) BDGM;

FIG. 8 shows registration results of rotated images using GM, SGM and BDGM: (a) 10° rotation, and (b) 30° rotation;

FIG. 9 shows test images for affine registration with small motion, where X marks the initial motion estimation;

FIG. 10 shows comparisons of the performance of the GM, SGM and BDGM regarding the small motion registration of the images in FIG. 9;

FIG. 11 shows two images used to test the registration under poor illumination conditions, in which X marks the initial motion estimation;

FIG. 12 shows a comparison of the performance of GM, SGM and BDGM in the registration of the images of FIG. 11;

FIG. 13 shows two panoramic images with large motion, in which X marks the initial motion estimation;

FIG. 14 shows the registration results for the large panoramic motion for the images in FIG. 13, using GM, SGM, and BDGM;

FIG. 15 shows two panoramic images with small motion, in which X marks the initial motion estimation;

FIG. 16 shows the registration results for the small panoramic motion of the images in FIG. 15 using GM, SGM, and BDGM;

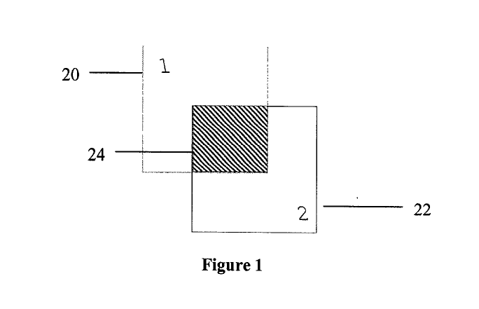

### DESCRIPTION OF THE PREFERRED EMBODIMENTS

The present invention is of a method for fast global motion estimation using a bi-gradient or a symmetric gradient scheme. Specifically, the method of the present invention estimates the parameters vector P by providing either a bi-directional approach to a location inside the interval, or a symmetric approach to the center value of the interval of each parameter. The BDGM or SGM can be used to obtain faster GM convergence, or convergence in cases where the GM method does not converge.

The principles and operation of a fast global motion estimation method using bi-directional or symmetric gradient schemes according to the present invention may be better understood with reference to the drawings and the accompanying description.

The method of the present invention as embodied in its two main embodiments represents a significant improvement over the GM. The invention described herein discloses in detail a procedure to estimate the optimal or center value of each interval of each of the parameters of the vector P such that the error in the estimated parameters is minimal. The global motion estimation algorithm gets as an input an estimate (which is as an initial guess) of the two translation parameters Δx and Δy from the eight parameters it has to estimate in an iterative procedure in the most general case. The other six motion parameters are initially assumed to be 0. No other information is required about the relative motion between the two images. In the BDGM formulation, the input images are used to approximate a virtual image that is situated optimally in the middle (not necessarily the center) of the parameters space P defining the geometrical transformation I₂→I₁ . In the SGM formulation the input images are used to approximate a virtual image that is situated in the center of the parameters space P, defining the geometrical transformation I₂→I₁. In other words, the BDGM algorithm is provided an initial guess of the intervals Δx and Δy, and proceeds in an iterative procedure to estimate the rest of the six parameters which lie in the interval of the parameters vector P. In contrast, the SGM algorithm is provided with an initial guess of the intervals and starts the procedure by dividing the two initial values into two equal subsections. After the completion of the first iteration that provides an initial interval for each of the other (up to six) parameters of P the BDGM algorithm chooses points that lie in the interval of each of these estimated initial values of the parameters of P, while the SGM algorithm takes the center of all the parameter values. This is the initial guess for the second iteration. After the completion of the second iteration, the BDGM algorithm chooses the middle (not necessarily the center) while the SGM algorithm takes the exact center of the newly (second iteration) estimated parameters values, and starts all over again.

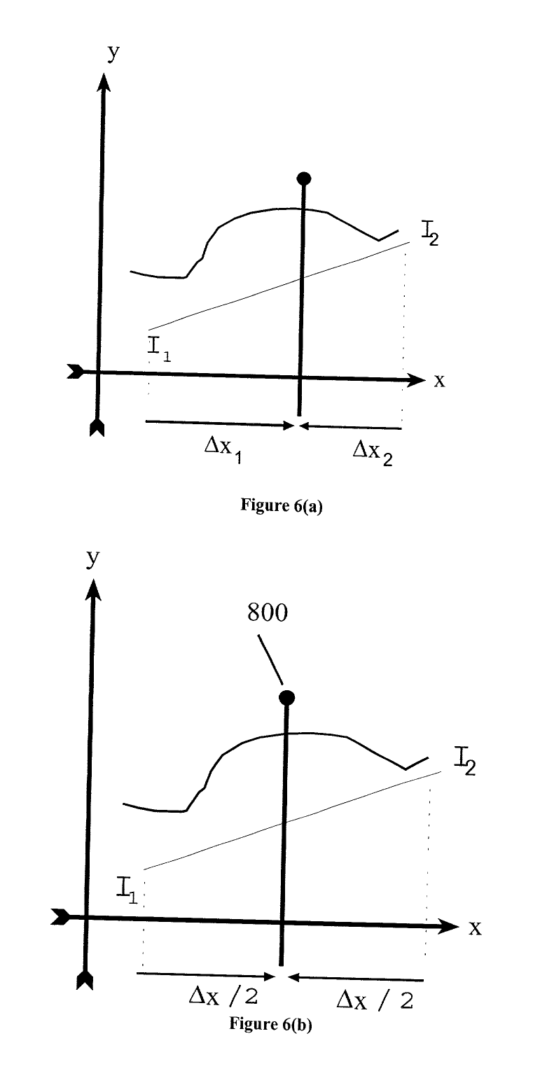

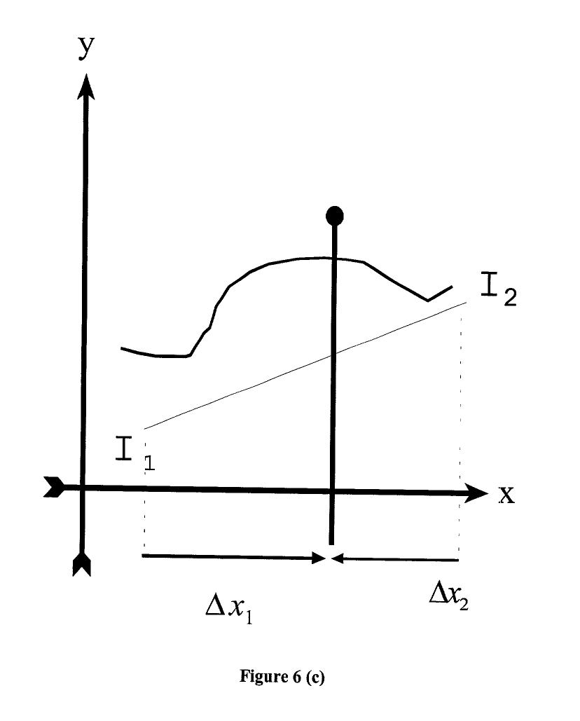

This idea is easy to illustrate in the case of translation. FIG. 6 shows an illustration given for simplification purposes only in a 1-D space (only translation in the x direction is estimated), of the key difference in the technique of approaching the common pixels between I₁ and I₂: (a) in regular prior art GM, pixels in I₁ are approximated by pixels in I₂ over the (1-D) interval Δx; (b) in SGM pixels in the center of the interval between I₁ and I₂ are approximated by pixels common to I₁ and I₂; while in (c) BDGM, pixels between I₁ and I₂ are approximated by pixels common to I₁ and I₂, i.e. the original interval is divided into two sub-intervals Δx₁ and Δx₂. A meeting point 800 in (b) and (c) is chosen optimally to minimize the approximation error and to speed-up the computation. A similar approach is used for two-dimensional (2-D) space to estimate 2-D translation, rotation, 2-D affine and pseudo-projective movements. The BDGM or SGM estimate respectively the internal or center value of each interval for each parameter as done in the 1-D case. In other words, the BDGM or SGM uses the common pixels to I₁ and I₂ in order to estimate the parameters that describe some internal location (BDGM) or the center (SGM) of the general translation, rotation, affine and pseudo-projective movements.

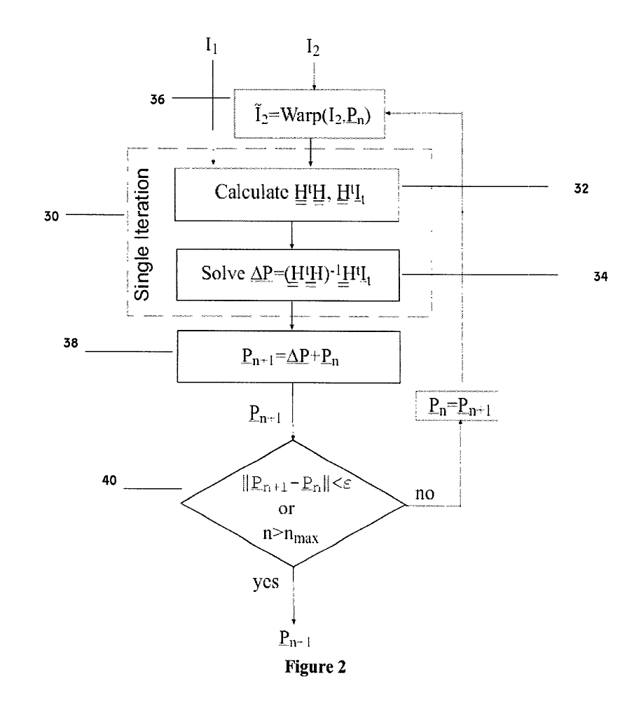

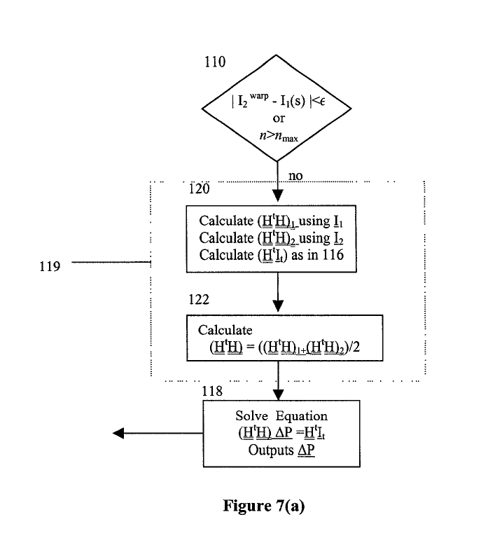

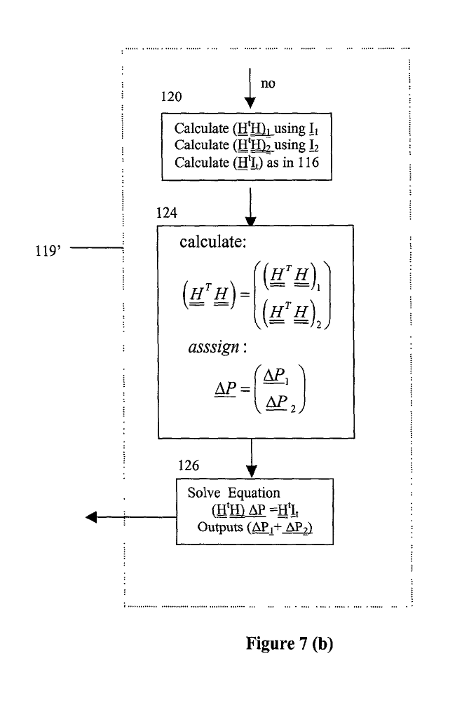

The key innovative feature of the SGM of the present invention, i.e. the symmetrical approach to the center value of each parameter interval, is shown schematically as a “replacement module” 119 in the block diagrams of FIG. 7a. Replacement module 119 is comprised of two novel steps 120 and 122. These steps facilitate a symmetric approach to motion estimation based on GM. Steps 120 and 122 replace steps 114 and 116 of the GM in FIG. 5. In step 122, the matrix (H^{t}H) is calculated symmetrically and separately for I₂ and I₁, unlike the calculation in step 114 of the GM method. Thus, replacement module 119 of the SGM replaces the single iteration module or phase 30 in FIG. 2. The rest of the GM algorithm remains unchanged.

The key innovative feature of the BDGM of the present invention, i.e. that the algorithm automatically approaches an optimal location inside each parameter interval (minimizes the estimation error), is shown schematically as a “replacement module” 119′ in the block diagrams of FIG. 7b. Replacement module 119′ is comprised of three key new and novel steps 120′, 124 and 126. Steps 120′ and 124 replace step 114 of the GM in FIG. 5. Step 126 replaces step 116 in FIG. 5. In steps 120′ and 124, the matrix (H^{t}H) is calculated bi-directionally and separately for I₂ and I₁, unlike the calculation in step 114 of the GM method. Step 126 combines two parameter vectors into a single one, unlike step 114 in FIG. 5. Similar to the SGM, replacement module 119′ of the BDGM replaces only the single iteration module or phase 30 in FIG. 2. The rest of the GM algorithm remains unchanged. In order to better understand the innovative features of both SGM and BDGM, reference is first made to some key regular GM features.

The governing equations that describe the physical aspects of the system that governs the global motion are non-linear. Thus, one cannot find a fast solver that produces the right 2 parameters for pure global translation, 4 parameters for image plane rotation, 6 parameters for 2-D affine motion, and 8 parameters for pseudo-projective motion. An efficient strategy to overcome the non-linear aspect of the problem uses linearization of the system of equations.

The basic GM formulation is given by Eqs. (38)-(41).

I(xᵢ⁽¹⁾)=I(xᵢ⁽²⁾) (38)

where xᵢ⁽¹⁾ and xᵢ⁽²⁾ are the current estimates of the coordinate of the i^{th} sample common to I₁ and I₂ satisfying:

xᵢ⁽¹⁾=xᵢ⁽²⁾+Δx (39)

Eq. 38 is solved by expanding I₂ in a first order Taylor expansion and solving for Δx:

$$I ( {x}_{i}^{( 1 )} ) = I ( {x}_{i}^{( 2 )} ) + \frac{\partial {I}_{2} ( {x}_{i}^{( 2 )} )}{\partial x} \cdot Δ x . \qquad ( 40 )$$

This point-wise expansion in the linearization causes an error estimated by Eq. 25

$${ϵ}_{GM} = ϵ ( {x}_{i}^{( 2 )} , Δ x ) = \frac{1}{2} \frac{{\partial }^{2} {I}_{2} ( {\tilde{x}}^{( 2 )} )}{\partial {x}^{2}} \cdot Δ {x}_{i}^{2} , \tilde{x} ∈ [ 0 , Δ x ] \qquad ( 41 )$$

Both the BDGM and the SGM of the present invention substantially improve the performance of the GM by estimating the optimal locations (BDGM) or center (SGM) of the parameters vector. In the 1-D case, Δx is the interval where the computation is taking place, and the GM error (Eq. 41) has a quadratic behavior and is proportional to Δx2. A main innovative feature of the BDGM and SGM of the present invention is in providing a way to decrease this error. Both the fact that there should be a decrease, and the way to achieve such a decrease are non-obvious, as detailed and demonstrated hereinbelow.

Referring again to the 1-D case for the sake of simplicity, the error is decreased according to the present invention by dividing the 1-D interval into sections or sub-intervals, The sections may be equal or non-equal in size. Specifically, the algorithm either yields automatically the location in the 1-D interval in which the algorithm operates (BDGM), or a-priori divides it into two equal sections (SGM), and reduces the error by a factor of 2 as shown below. In general, the error is proportional to Δx²/n, where n is the number of sections into which the original interval is divided. The same approach is used when rotation, 2-D affine and pseudo-projective movements are present. For example, if a true rotation includes a rotation of 30° between two images, the SGM will estimate this rotation by dividing it into two parts: from 0 to 15° and from 15° to 30°. The SGM estimates the correct exact center value of each interval for each parameter of the parameters vector describing the particular motion (each of the four parameters for rotation in the example above). In contrast, the BDGM will not start with an a-priori division of the rotation into two equal parts, but will run an iterative optimization that yields the optimum (not necessarily center) location of each rotation parameter value interval.

The solver of the present invention is based on an iterative algorithm. In the regular GM methodology, as the number of iterations increases, the error is reduced. As stated and shown below, by using the BDGM or SGM of the present invention the error can be reduced by factor of 2 when the problem is solved in two half sub-intervals. Thus, the same error as in the regular GM can be reached in the iterative procedure of either embodiment of the method of the present invention much faster.

In order to more appropriately distinguish between the two main embodiments of the method of the present invention, i.e. the SGM and BDGM, the two are presented separately below.

SGM

In the 1-D case, in order to reduce the estimation error, and therefore improves 20 the convergence, the estimation error ε_{GM}(xᵢ⁽²⁾,Δx) of Eq. 41 is reformulated symmetrically in respect to Δx according to FIG. 6(b), to give a basic SGM formulation:

I₁(xᵢ⁽¹⁾−Δx/2)=I₂(xᵢ⁽²⁾+Δx/2) (42)

Expanding both sides using Taylor expansion:

$$\begin{matrix}{I}_{1} ( {x}_{i}^{( 1 )} ) - \frac{\partial {I}_{1} ( {x}_{i}^{( 1 )} )}{\partial x} \cdot \frac{Δ x}{2} + {ϵ}_{GM} ( {x}_{i}^{( 1 )} , \frac{Δ x}{2} ) = {I}_{2} ( {x}_{i}^{( 2 )} ) + \frac{\partial {I}_{2} ( {x}_{i}^{( 2 )} )}{\partial x} \cdot \frac{Δ x}{2} + {ϵ}_{GM} ( {x}_{i}^{( 2 )} , \frac{Δ x}{2} ) & ( 43 ) \\ \underbrace{{I}_{2} ( {x}_{i}^{( 2 )} ) - {I}_{1} ( {x}_{i}^{( 1 )} )}_{- {I}_{t}} + ( \frac{\partial {I}_{1} ( {x}_{i}^{( 1 )} )}{\partial x} + \frac{\partial {I}_{2} ( {x}_{i}^{( 2 )} )}{\partial x} ) \cdot \frac{Δ x}{2} + \underbrace{{ϵ}_{GM} ( {x}_{i}^{( 1 )} , \frac{Δ x}{2} ) - {ϵ}_{GM} ( {x}_{i}^{( 2 )} , \frac{Δ x}{2} )}_{{ϵ}_{GM} ( {x}_{i}^{( 2 )} , Δ x )} = 0 & ( 44 )\end{matrix}$$

Next, an upper bound is derived for a symmetric linearization error associated with Eq. 43:

ε_{SGM}(xᵢ⁽²⁾,Δx)≦2ε_{GM}(xᵢ⁽²⁾,Δx/2) (45)

The error term is quadratic in ΔX. Then by comparing ε_{SGM} to the regular GM error ε_{GM} of Eq. 41:

$$\begin{matrix}{ϵ}_{GM} ( {x}_{i}^{( 2 )} , \frac{Δ x}{2} ) = \frac{1}{4} {ϵ}_{GM} ( {x}_{i}^{( 2 )} , Δ x ) & ( 46 ) \\ {ϵ}_{SGM} ( {x}_{i}^{( 2 )} , Δ x ) = 2 {ϵ}_{GM} ( {x}_{i}^{( 2 )} , \frac{Δ x}{2} ) \\ = \frac{1}{2} {ϵ}_{GM} ( {x}_{i}^{( 2 )} , Δ x ) . & ( 47 )\end{matrix}$$

A better approximation error analysis can be derived by expanding ε_{SGM(x}ᵢ⁽²⁾,ΔX):

$$\begin{matrix}{ϵ}_{GM} ( {x}_{i}^{( 2 )} , \frac{Δ x}{2} ) - {ϵ}_{GM} ( {x}_{i}^{( 1 )} , \frac{Δ x}{2} ) = \frac{1}{4} {ϵ}_{GM} ( {x}_{i}^{( 2 )} , Δ x ) - \frac{1}{4} {ϵ}_{GM} ( {x}_{i}^{( 1 )} , Δ x ) \\ = \frac{1}{8} Δ {x}_{i}^{2} ( \frac{{\partial }^{2} {I}_{2} ( {\tilde{x}}_{i}^{( 2 )} )}{\partial {x}^{2}} - \frac{{\partial }^{2} {I}_{1} ( {\tilde{x}}_{i}^{( 1 )} )}{\partial {x}^{2}} ) \\ \approx \frac{1}{8} Δ {x}_{i}^{2} ( \frac{{\partial }^{3} {I}_{2} ( \tilde{x} )}{\partial {x}^{3}} Δ x ) \\ = \frac{{\partial }^{3} {I}_{2} ( \tilde{x} )}{\partial {x}^{3}} Δ \frac{{x}^{3}}{8}\end{matrix} \qquad ( 48 )$$

The smaller the symmetric linearization error ε_{SGM}, the better is the convergence rate. If ε_{SGM}=0, Eq. 40 converges in a single iteration.

The 1-D case above was treated in detail as an example only, in order to demonstrate the main ideas of the invention. The 2-D “general” cases, which include translation, rotation, affine and pseudo-projective movements are treated next. The general approach is more difficult to visually demonstrate that the simple 1-D approach of FIG. 6b. In the general 2-D case, the “center” of each parameter in the parameters vector P is computed iteratively to a final value, and this reduces the estimation error and therefore improves substantially the convergence rate.

In the general 2-D case, the SGM is formulated using the motion parameters vector P

$${\underline{P}}^{*} = arg {min}_{\underline{P}} \{ {\sum }_{( {x}_{i} , {y}_{i} ) ∈ s} {( {I}_{2} ( {x}_{i}^{( 1 )} , {y}_{i}^{( 1 )} , \frac{\underline{P}}{2} ) - {I}_{2} ( {x}_{i}^{( 2 )} , {y}_{i}^{( 2 )} , - \frac{\underline{P}}{2} ) )}^{2} \} \qquad ( 49 )$$

rᵢ(xᵢ⁽¹⁾,yᵢ⁽¹⁾,P)=I₂(xᵢ⁽¹⁾,yᵢ⁽¹⁾,P/2)−I₁(xᵢ⁽²⁾,yᵢ⁽²⁾,−P/2) (50)

From Eq. 50 one has

$$\frac{\partial {r}_{i} ( {x}_{i}^{( 1 )} , {y}_{i}^{( 1 )} , \underline{P} )}{\partial \underline{P}} = \frac{\partial {I}_{2} ( {x}_{i}^{( 2 )} , {y}_{i}^{( 2 )} , \frac{\underline{P}}{2} )}{\partial \underline{P}} - \frac{\partial {I}_{1} ( {x}_{i}^{( 2 )} , {y}_{i}^{( 2 )} , - \frac{\underline{P}}{2} )}{\partial \underline{P}} \qquad ( 51 )$$

Using the chain rule

$$\frac{\partial {I}_{1} ( {x}_{i}^{( 1 )} , {y}_{i}^{( 1 )} , \frac{\underline{P}}{2} )}{\partial \underline{P}}$$

is expressed in terms of

$$\frac{\partial {I}_{1} ( {x}_{i}^{( 1 )} , y )}{\partial \underline{P}} :$$

$$\frac{\partial {I}_{1} ( {x}_{i}^{( 1 )} , {y}_{i}^{( 1 )} , \frac{\underline{P}}{2} )}{\partial \underline{P}} = \frac{\partial {I}_{1} ( {x}_{i}^{( 1 )} , {y}_{i}^{( 1 )} , \frac{\underline{P}}{2} )}{\partial ( \frac{\underline{P}}{2} )} = \frac{1}{2} \frac{\partial {I}_{1} ( {x}_{i}^{( 1 )} , {y}_{i}^{( 1 )} , \underline{P} )}{\partial \underline{P}} . \qquad ( 52 )$$

Therefore, one has

$$\frac{\partial {r}_{i} ( {x}_{i}^{( 1 )} , {y}_{i}^{( 1 )} , \frac{\underline{P}}{2} )}{\partial \underline{P}} = \frac{1}{2} ( \frac{\partial {I}_{2} ( {x}_{i}^{( 2 )} , {y}_{i}^{( 2 )} , \frac{\underline{p}}{2} )}{\partial \underline{P}} + \frac{\partial {I}_{ 1} ( {x}_{i}^{( 1 )} , {y}_{i}^{( 1 )} , \frac{\underline{P}}{2} )}{\partial \underline{P}} ) \qquad ( 53 )$$

Assuming

$$\frac{\partial {I}_{2} ( {x}_{i}^{( 2 )} , {y}_{i}^{( 2 )} , \frac{\underline{P}}{2} )}{\partial \underline{P}} \approx \frac{\partial {I}_{1} ( {x}_{i}^{( 1 )} , {y}_{i}^{( 1 )} , \frac{\underline{P}}{2} )}{\partial \underline{P}} \qquad ( 54 )$$

one gets

$$\frac{\partial {r}_{i} ( {x}_{i}^{( 1 )} , {y}_{i}^{( 1 )} , \frac{\underline{P}}{2} )}{\partial \underline{P}} \approx \frac{\partial {I}_{2} ( {x}_{i}^{( 2 )} , {y}_{i}^{( 2 )} , \frac{\underline{p}}{2} )}{\partial \underline{P}} \qquad ( 55 )$$

Taking the second derivative and using Eq. 54

$$\frac{{\partial }^{2} {r}_{i} ( {x}_{i}^{( 1 )} , {y}_{i}^{( 1 )} , \frac{\underline{P}}{2} )}{\partial \underline{P}} = \frac{1}{2} ( \frac{1}{2} \frac{{\partial }^{2} {I}_{2} ( {x}_{i}^{( 2 )} , {y}_{i}^{( 2 )} )}{\partial {\underline{P}}^{2}} - \frac{1}{2} \frac{{\partial }^{2} {I}_{1} ( {x}_{i}^{( 1 )} , {y}_{i}^{( 1 )} )}{\partial {\underline{P}}^{2}} ) \approx 0. \qquad ( 56 )$$

Comparing Eq. 56 to Eqs. 18 and 23

$${C}_{1}^{SGM} = \frac{{C}_{1}^{GM}}{2} \qquad ( 57 )$$

C₂^{SGM}=C₂^{GM} (58)

Therefore, the SGM will generally outperform the regular GM algorithm in the convergence rate due to its reduced linearization error.

SGM Algorithm Flow

The matrix (H^{t}H) is in general calculated separately as respectively a first matrix for I₁ and a second matrix for I₂ in matrix calculation step 120, using preferably the following formulations

$$\begin{matrix}{( {{H}_{=}}^{t} {H}_{=} )}_{k , j}^{{I}_{1}} = {\sum }_{i} \frac{\partial {I}_{1} ( {x}_{i}^{( 1 )} , {y}_{1}^{i} )}{\partial {P}_{k}} \frac{\partial {I}_{i} ( {x}_{i}^{( 1 )} , {y}_{2}^{i} )}{\partial {P}_{j}} & ( 59 ) \\ {( {{H}_{=}}^{t} {H}_{=} )}_{k , j}^{{I}_{2}} = {\sum }_{i} \frac{\partial {I}_{2} ( {x}_{i}^{( 2 )} , {y}_{2}^{i} )}{\partial {P}_{k}} \frac{\partial {I}_{2} ( {x}_{i}^{( 2 )} , {y}_{2}^{i} )}{\partial {P}_{j}} & ( 60 )\end{matrix}$$

Following step 118 in FIG. 7a

(H^{t}H)^{SGM}P^{SGM}=H^{t}Iₜ (61)

where a combined matrix (H^{t}H)^{SGM} is preferably given by

$${( {{H}_{=}}^{t} {H}_{=} )}_{k , j}^{SGM} = \frac{1}{2} ( {( {{H}_{=}}^{t} {H}_{=} )}_{k , j}^{{I}_{1}} + {( {{H}_{=}}^{t} {H}_{=} )}_{k , j}^{{I}_{2}} ) \qquad ( 62 )$$

and (H^{t}Iₜ) is preferably calculated according to Eq. 17.

The SGM returns P^{SGM} as the result denoted as ΔP in FIG. 7a.

BDGM

In the 1-D case of FIG. 6c, in order to reduce the estimation error by decreasing the linearization error in the interval [0 . . . ΔX], the algorithm is allowed to partition optimally this interval using the following formulation

I(xᵢ⁽¹⁾−Δxᵢ)=I(xᵢ⁽²⁾−Δx₂) (63)

Using Eq. 41 and a Taylor expansion of Eq. 63

$$\begin{matrix}{I}_{1} ( {x}_{i}^{( 1 )} ) - \frac{\partial {I}_{1} ( {x}_{i}^{( 1 )} )}{\partial x} \cdot Δ {x}_{1} + {ϵ}_{GM} ( {x}_{i}^{( 1 )} , Δ {x}_{1} ) = {I}_{2} ( {x}_{i}^{( 2 )} ) + \frac{\partial {I}_{2} ( {x}_{i}^{( 2 )} )}{\partial x} \cdot Δ {x}_{2} + {ϵ}_{GM} ( {x}_{i}^{( 2 )} , Δ {x}_{2} ) & ( 64 ) \\ \frac{\partial {r}_{i} ( {x}_{i}^{( 1 )} , {y}_{i}^{( 1 )} , {P}_{-} )}{\partial {P}_{-}} = \frac{\partial {I}_{2} ( {x}_{i}^{( 2 )} , {y}_{i}^{( 2 )} , \frac{{p}_{-}}{2} )}{\partial {P}_{-}} - \frac{\partial {I}_{1} ( {x}_{i}^{( 2 )} , {y}_{i}^{( 2 )} , - \frac{{p}_{-}}{2} )}{\partial {P}_{-}} & ( 65 )\end{matrix}$$

where the motion between I₂ and I₁ is given by:

Δx=Δxᵢ+Δx₂ (66)

We analyze the error term of Eq. 65:

$$\begin{matrix}2 \cdot {ϵ}_{BDGM} ( {x}_{i}^{( 1 )} , {x}_{i}^{( 2 )} , Δ {x}_{1} , Δ {x}_{2} ) = 2 ( {ϵ}_{GM} ( {x}_{i}^{( 2 )} , Δ {x}_{2} ) - {ϵ}_{GM} ( {x}_{i}^{( 1 )} , Δ {x}_{1} ) ) \\ = \frac{{\partial }^{2} {I}_{2} ( {\tilde{x}}^{( 2 )} )}{\partial {x}^{2}} Δ {x}_{2}^{2} - \frac{{\partial }^{2} {I}_{1} ( {\tilde{x}}^{( 1 )} )}{\partial {x}^{2}} Δ {x}_{1}^{2} \\ = \frac{{\partial }^{2} {I}_{2} ( {\tilde{x}}^{( 2 )} )}{\partial {x}^{2}} Δ {x}_{2}^{2} - \frac{{\partial }^{2} {I}_{2} ( {\tilde{x}}^{( 2 )} )}{\partial {x}^{2}} Δ {x}_{1}^{2} + \underbrace{\frac{{\partial }^{2} {I}_{2} ( {\tilde{x}}^{( 2 )} )}{\partial {x}^{2}} Δ {x}_{1}^{2}}_{0} - \\ \frac{{\partial }^{2} {I}_{1} ( {\tilde{x}}^{( 1 )} )}{\partial {x}^{2}} Δ {x}_{1}^{2} \\ = \frac{{\partial }^{2} {I}_{2} ( {\tilde{x}}^{( 2 )} )}{\partial {x}^{2}} ( Δ {x}_{2}^{2} - Δ {x}_{1}^{2} ) + Δ {x}_{1}^{2} ( \frac{{\partial }^{2} {I}_{2} ( {\tilde{x}}^{( 2 )} )}{\partial {x}^{2}} - \frac{{\partial }^{2} {I}_{1} ( {\tilde{x}}^{( 1 )} )}{\partial {x}^{2}} ) \\ = \frac{{\partial }^{2} {I}_{1} ( {\tilde{x}}^{( 2 )} )}{\partial {x}^{2}} ( Δ {x}_{2} - Δ {x}_{1} ) ( Δ {x}_{2} - Δ {x}_{1} ) + Δ {x}_{1}^{2} ( \frac{{\partial }^{3} {I}_{2} ( \tilde{x} )}{\partial {x}^{3}} Δ x )\end{matrix} \qquad ( 67 )$$

Substituting Eq. 66 into Eq. 67:

$${ϵ}_{BDGM} ( {x}_{i}^{( 1 )} , {x}_{i}^{( 2 )} , Δ {x}_{1} , Δ {x}_{2} ) = \frac{Δ x}{2} ( \frac{{\partial }^{2} {I}_{2} ( {\tilde{x}}^{( 2 )} )}{\partial {x}^{2}} \cdot ( Δ {x}_{2} - Δ {x}_{1} ) + Δ {x}_{1}^{2} \frac{{\partial }^{3} {I}_{2} ( \tilde{x} )}{\partial {x}^{3}} ) \qquad ( 68 )$$

and ε_{BDGM} is the error of the bi-directional GM. Since the solution of Eq. 65 minimizes ε_{BDGM} directly, we expect to achieve superior convergence results. For the symmetric case where Δx₁=Δx₂=Δx/2, the first term of Eq. 68 vanishes and

$${ϵ}_{BDGM} ( {x}_{i}^{( 1 )} , {x}_{i}^{( 2 )} , Δ {x}_{1} , Δ {x}_{2} ) = \frac{{\partial }^{3} {I}_{2} ( \tilde{x} )}{\partial {x}^{3}} Δ \frac{{x}^{3}}{8} \qquad ( 69 )$$

An extension into two dimensions with general motion models is given next for the BDGM algorithm.

As in the SGM, the 1-D BDGM case was treated in detail as an example only, in order to demonstrate the main ideas of the invention. In the general 2-D case, the location of each parameter in the parameters vector P is computed iteratively to a final value, and this reduces the estimation error and therefore improves substantially the convergence rate.

In the general 2-D case, the BDGM is formulated using the motion parameters vector P

$${{P}_{-}}^{*} = arg {min}_{{P}_{-}} \{ {\sum }_{( {x}_{i} , {y}_{i} ) εs} {( {I}_{2} ( {x}_{i}^{( 2 )} , {y}_{i}^{( 2 )} , {P}_{- 2} ) - {I}_{1} ( {x}_{i}^{( 1 )} , {y}_{i}^{( 1 )} , - {P}_{- 1} ) )}^{2} \} \qquad ( 70 )$$

where P₁ and P₂ have the same dimensions as the motion parameters vector used in the GM formulations. The overall motion is given by

P=P₁+P₂. (71)

Let k,mε[0 . . . 1],k+m=1, then:

P₁=k·P

P₂=m·P (72)

rᵢ(xᵢ⁽¹⁾,yᵢ⁽¹⁾,P)=I₂(xᵢ⁽¹⁾,yᵢ⁽¹⁾,P₂)−I₁(xᵢ⁽²⁾,yᵢ⁽²⁾,−P₁)=I₂(xᵢ⁽¹⁾,yᵢ⁽¹⁾,kP)−I₁(xᵢ⁽²⁾,yᵢ⁽²⁾,−mP) (73)

$$\begin{matrix}\begin{matrix}\frac{\partial {r}_{i} ( {x}_{i}^{( 1 )} , {y}_{i}^{( 1 )} , {P}_{-} )}{\partial {P}_{-}} = \frac{\partial {I}_{2} ( {x}_{i}^{( 2 )} , {y}_{i}^{( 2 )} , {kP}_{-} )}{\partial {P}_{-}} - \frac{\partial {I}_{1} ( {x}_{i}^{( 1 )} , {y}_{i}^{( 1 )} , {- mP}_{-} )}{\partial {P}_{-}} \\ = k \frac{\partial {I}_{2} ( {x}_{i}^{( 2 )} , {y}_{i}^{( 2 )} )}{\partial {P}_{-}} + m \frac{\partial {I}_{1} ( {x}_{i}^{( 1 )} , {y}_{i}^{( 1 )} )}{\partial {P}_{-}}\end{matrix} & ( 74 ) \\ \frac{{\partial }^{2} {r}_{i} ( {x}_{i}^{( 1 )} , {y}_{i}^{( 1 )} , {P}_{-} )}{\partial {{P}_{-}}^{2}} = {k}^{2} \frac{{\partial }^{2} {I}_{2} ( {x}_{i}^{( 2 )} , {y}_{i}^{( 2 )} )}{\partial {{P}_{-}}^{2}} + {m}^{2} \frac{{\partial }^{2} {I}_{1} ( {x}_{i}^{( 1 )} , {y}_{i}^{( 1 )} )}{\partial {{P}^{2}}_{-}} & ( 75 )\end{matrix}$$

By assuming symmetry one gets

$$\begin{matrix}\frac{{\partial }^{2} {r}_{i} ( {x}_{i}^{( 1 )} , {y}_{i}^{( 1 )} , {P}_{-} )}{\partial {{P}_{-}}^{2}} = ( {k}^{2} + m ) \frac{{\partial }^{2} {I}_{2} ( {x}_{i}^{( 2 )} , {y}_{i}^{( 2 )} )}{\partial {{P}^{2}}_{-}} \\ = ( {k}^{2} + {( k - 1 )}^{2} ) \frac{{\partial }^{2} {I}_{2} ( {x}_{i}^{( 2 )} , {y}_{i}^{( 2 )} )}{\partial {{P}^{2}}_{-}} \\ = ( 2 k - 1 ) \frac{{\partial }^{2} {I}_{2} ( {x}_{i}^{( 2 )} , {y}_{i}^{( 2 )} )}{\partial {{P}^{2}}_{-}}\end{matrix} \qquad ( 76 )$$

Thus

C₂^{BDGM=C}₂^{GM} (77)

And the optimal partitioning of the interval [0. . . P], which minimizes

$$\vert \frac{{\partial }^{2} r ( {x}_{i}^{( 1 )} , {y}_{i}^{( 1 )} , {P}_{-} )}{\partial {{P}_{-}}^{2}} \vert ,$$

is the symmetric approach (k=1/2) Furthermore, the partitioning used by the regular GM is worse than the bi-directional formulation, since

$$\vert \frac{{\partial }^{2} r ( {x}_{i}^{( 1 )} , {y}_{i}^{( 1 )} , \underline{P} )}{\partial {\underline{P}}^{2}} \vert$$

is maximized for k=0, m=1 or k=1, m=0.

BDGM Algorithm Flow

The matrix (H^{t}H) is in general calculated separately as respectively a first matrix for I₁ and a second matrix for I₂ in matrix calculation step 120′ in FIG, 7b, using preferably the following formulations

$$\begin{matrix}{( {{H}_{=}}^{t} {H}_{=} )}_{k , j}^{{I}_{1}} = {\sum }_{i} \frac{\partial {I}_{1} ( {x}_{i}^{( 2 )} , {y}_{i}^{( 2 )} )}{\partial {P}_{k}} \frac{\partial {I}_{2} ( {x}_{i}^{( 2 )} , {y}_{i}^{( 2 )} )}{\partial {P}_{j}} & ( 78 ) \\ {( {{H}_{=}}^{t} {H}_{=} )}_{k , j}^{{I}_{2}} = {\sum }_{i} \frac{\partial {I}_{2} ( {x}_{i}^{( 2 )} , {y}_{i}^{( 2 )} )}{\partial {P}_{k}} \frac{\partial {I}_{2} ( {x}_{i}^{( 2 )} , {y}_{i}^{( 2 )} )}{\partial {P}_{j}} & ( 79 )\end{matrix}$$

Let

H^{BDGM}^{^{Δ}}[H^{I}^{₁}H^{I}^{₂}] (80)

H^{BDGM} is a matrix of dimensions (nₚᵢₓₑₗₛ×2·nₚₐᵣₐₘ), where nₚₐᵣₐₘ is the number of motion parameters and nₚᵢₓₑₗₛ is the number of pixels common to I₂ and I₁.

1. Denote by P^{BDGM} the BDGM parameters vector. Then

$${\underline{P}}^{BDGM} = [ \begin{matrix}{\underline{P}}^{1} \\ {\underline{P}}^{2}\end{matrix} ] \qquad ( 81 )$$

P¹ and P² are vectors of dimension (nₚₐᵣₐₘ×1)

2. The solution of the equation in step 126 of FIG. 7b is

((H^{BDGM})^{t}H^{BDGM})P^{BDGM}=(H^{BDGM})^{t}Iₜ (82)

where Iₜ is similar to the one used in the Basic GM. After solving Eq. 82, the solution P^{BDGM} is given by:

P^{BDGM}=P¹+P² (83)

### EXPERIMENTAL RESULTS

Exemplary performances of the SGM and BDGM embodiments of the method of the present invention in various motion estimation problems, and a comparison with GM results obtained in the same problems are given next. The numerical results are expressed in terms of alignment error vs. the number of iterations needed for convergence. Real and simulated image pairs were used. The same implementations of the iterative refinement and multi-scale embedding were used for the SCM, BDGM and GM algorithms. Thus, the only difference is in the bi-directional approach in BDGM and the symmetric approach to a “center point” of parameter intervals in SGM. The multi-scale decomposition is preferably constructed using a three-tap filter [⅓, ⅓, ⅓] and the derivative is preferably approximated using [½ 0 −½], for example by following M. Elad, P. Teo, Y. Hel-Or, “Optimal Filters For Gradient-Based Based Motion Estimation”, Technical Report #111, HP Lab, 1997, and E. P. Simoncelli, “Design of multi-dimensional derivatives filters”, IEEE International Conf. on Image Processing, Austin, Tex., 1994. Other filters may be also used. The initial estimate is an estimate of the translation parameters. The SGM and BDGM are tested by estimating large and small motions using several motion models: rotation, affine and pseudo-projective. “Small” rotation motion is defined as a rotation of typically less than about 10 degrees. “Small” translation is defined as typically less than 10 pixels in the lowest resolution. Conversely, “large” rotation motion is defined as equal to or more than 10 degrees, and “large” translation is defined as typically more than 10 pixels in the lowest resolution. “Very large” rotations are rotations of typically more than about 30 degrees.

Estimation of Large and Very Large Rotations

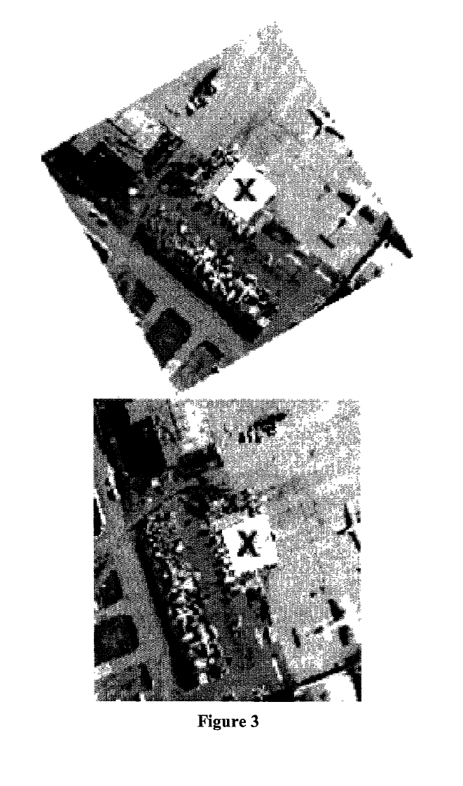

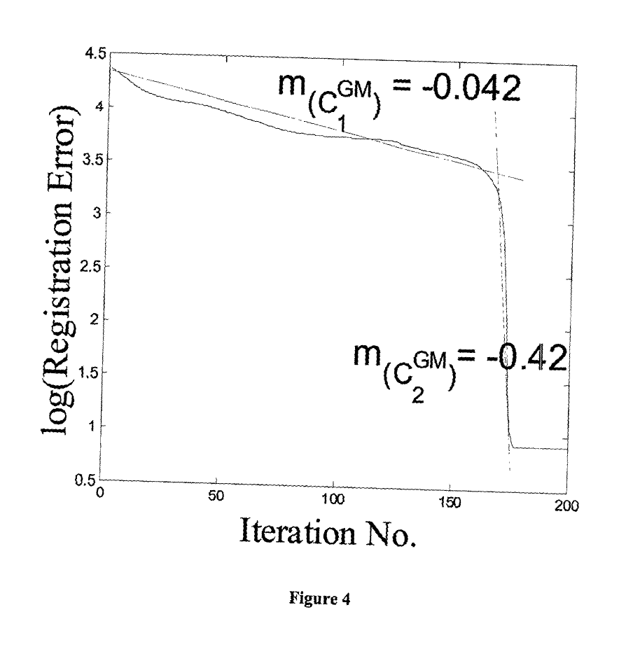

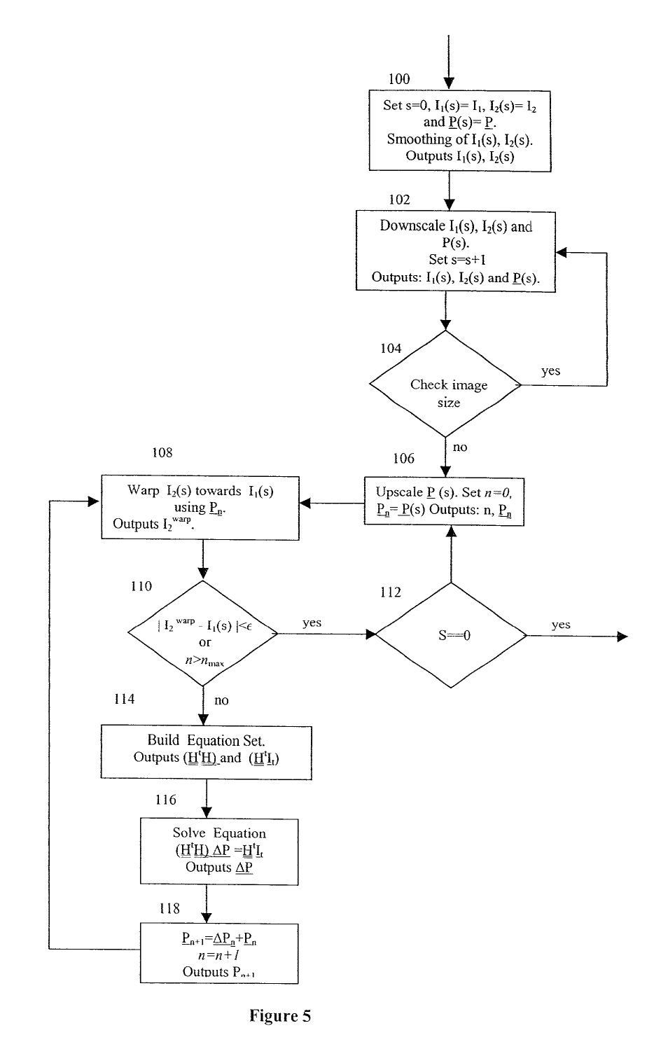

The estimation of large and very large rotations is illustrated using the image of FIG. 3. The image is rotated using a bilinear interpolation, while the background areas created by the rotation are padded with zeros. The registration is calculated using a linearized rotation model:

x₁=a·x₂−b·y₂+c

y₁=b·x₂+a·y₂+f (84)

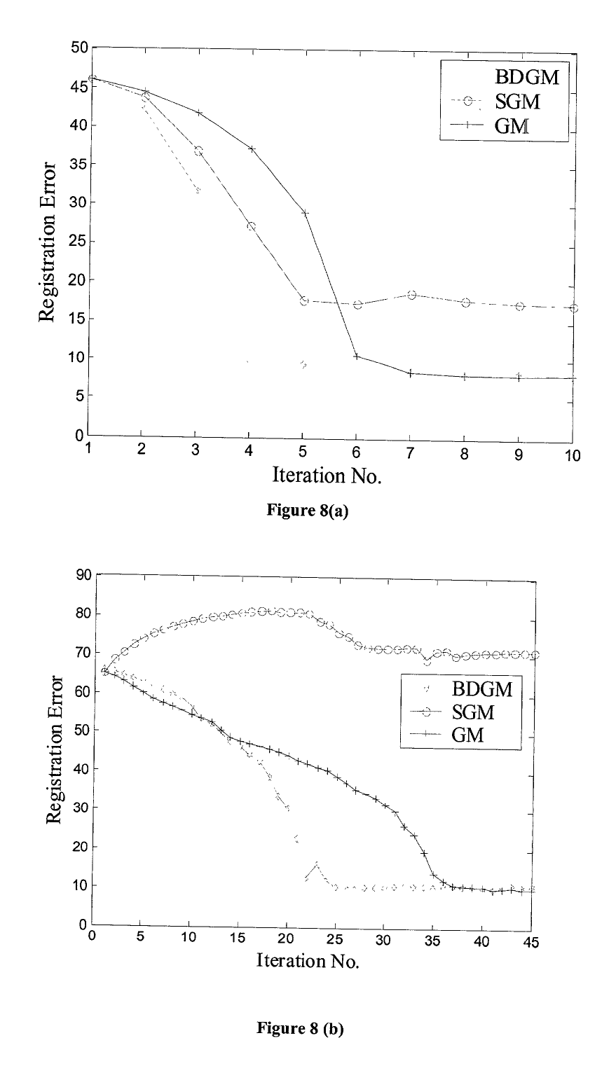

FIG. 8(a) shows the performance of registering an image rotated by 10°, which is considered to be a large rotation. The BDGM converges twice as fast as the GM:4 iterations compared to 7 iterations. The SGM converges in 5 iterations. Both the BDGM and the SGM significantly outperform the GM by converging in 25 iterations compared to the GM's 37 iterations. This means that we get the same accuracy with fewer iterations. In other words, the same results are achieved much faster than with the regular GM.

Estimation of Small Affine Motion

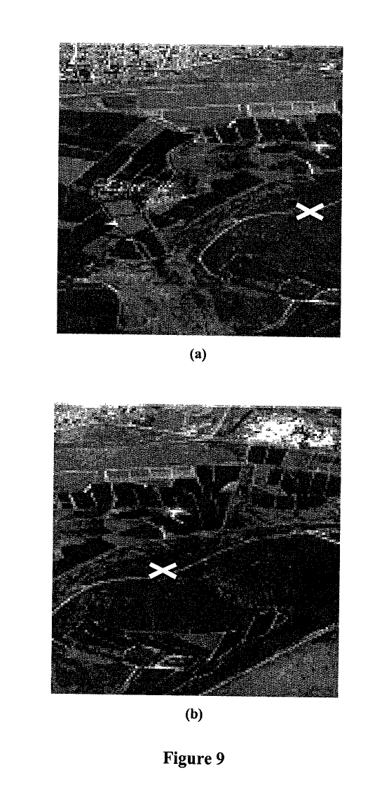

According to Eqs. 57 and 77 respectively, the SGM and BDGM are expected to perform similarly to the GM when registering small motions. In order to verify this experimentally, the two images in FIG. 9 (a, b) were registered using the affine motion model:

x₁=a·x₂+b·y₂+c

y₁=d·x₂+e·y₂+f (85)

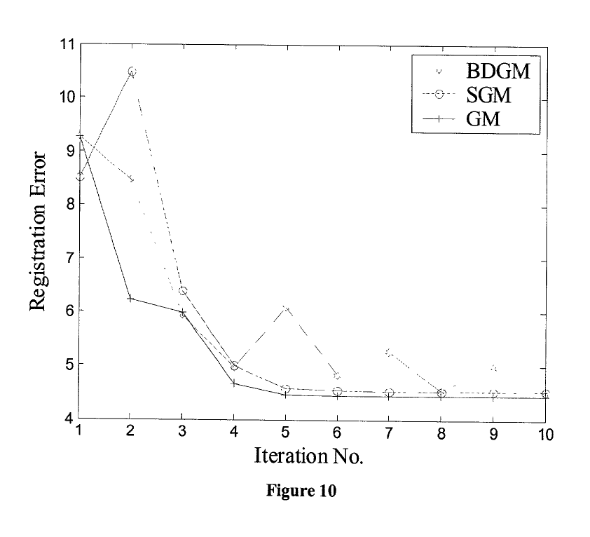

As in FIG. 3, the X mark indicates the common location where the computations take place. The results of estimation of small affine motion obtained with both GM and BDGM using the same conditions are presented in FIG. 10. The GM, SGM and BDGM algorithms convergence is similar, occurring after 4-5 iterations.

Registration of Images with Low Contrast

Instability in the registration process can also be attributed to images that have low contrast. In this type of images, the spatial derivatives are very small

$$\frac{\partial r ( {x}_{i}^{( 1 )} , {y}_{i}^{( 1 )} , \underline{P} )}{\partial \underline{P}} \to 0 \frac{\partial r ( {x}_{i}^{( 1 )} , {y}_{i}^{( 1 )} , \underline{P} )}{\partial \underline{P}} \to 0 \\ \frac{{\partial }^{2} r ( {x}_{i}^{( 1 )} , {y}_{i}^{( 1 )} , \underline{P} )}{\partial {\underline{P}}^{2}} \to 0 \frac{{\partial }^{2} r ( {x}_{i}^{( 1 )} , {y}_{i}^{( 1 )} , \underline{P} )}{\partial {\underline{P}}^{2}} \to 0 \qquad ( 86 )$$

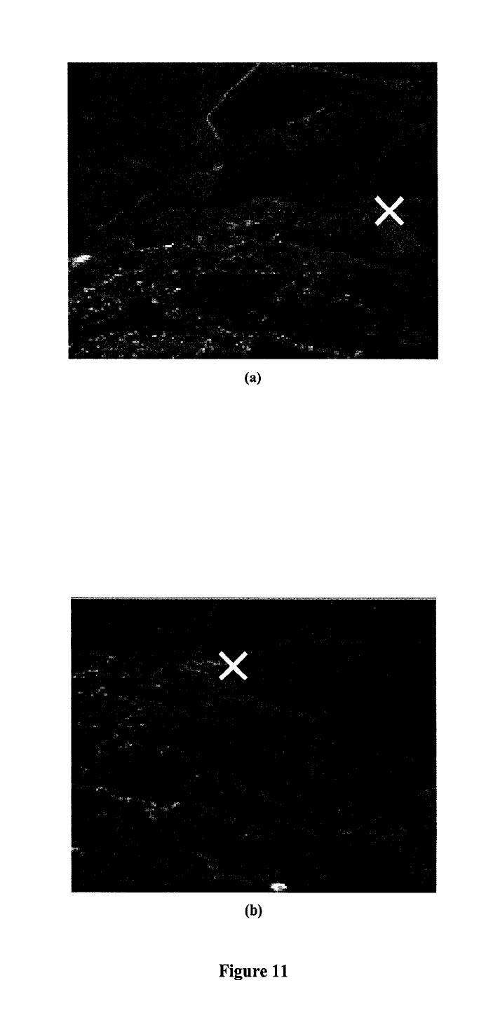

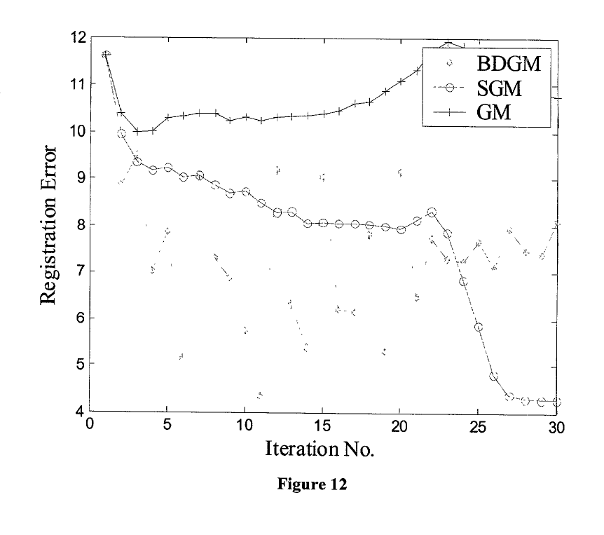

Under such conditions, according to Eqs. 23 and 24, the convergence rate of the GM deteriorates. The two images presented in FIG. 11(a, b) are real airborne images, which are registered using the affine motion model defined by Eq. 85. As in FIGS. 3 and 9, the X mark indicates common locations between the images where the computation starts. The convergence results, presented in FIG. 12, show that the SGM is able to converge to the solution (after ca. 26 iterations), while the GM completely diverges. There is no numerical instability of the SGM in the proximity of the solution, in contrast to the divergence of the GM. Thus, the SGM yields clearly superior results and enables registration of images with low contrast, a registration that is not possible with prior art GM. The BDGM is also able to converge to the solution, although it oscillates before its convergence.

Estimation of Large and Very Large Panoramic Motion

The registration of panoramic images is of special importance, since it is the basis for most mosaic-based applications discussed in the Background section. The motion model used for panoramic image registration is the pseudo-projective model (MAN94 and SZE94):

$${x}_{1} = \frac{a \cdot {x}_{2} + b \cdot {y}_{2} + c}{g \cdot {x}_{2} + h \cdot {y}_{2} + 1} \\ {y}_{1} = \frac{d \cdot {x}_{2} + e \cdot {y}_{2} + f}{g \cdot {x}_{2} + h \cdot {y}_{2} + 1} \qquad ( 87 )$$

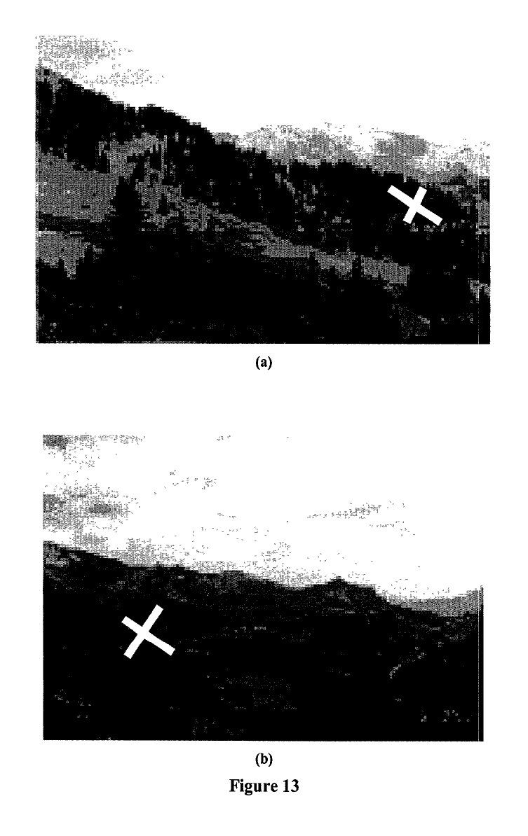

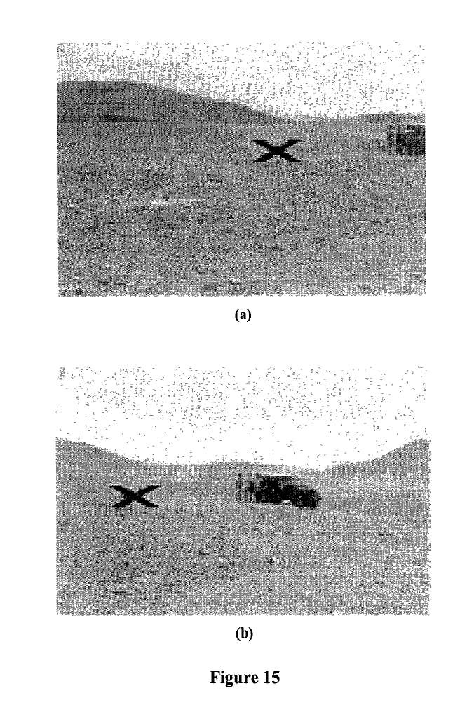

Due to large number of unknowns and the non-linear nature of Eq. 87, the GM based registration becomes slow and unstable. Two sets of images photographed by a regular 35 mm cameras were used to compare between the performance of the GM and SGM registration algorithms: FIG. 13 for a large panoramic motion and FIG. 15 for a small panoramic motion. The X mark in each indicates the common location where the computations start.

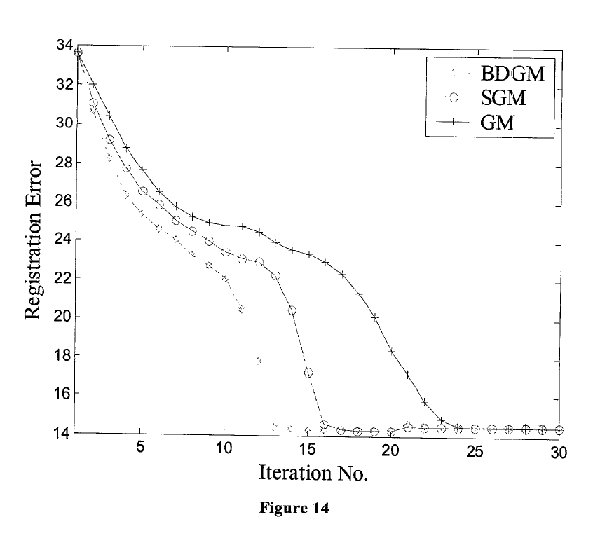

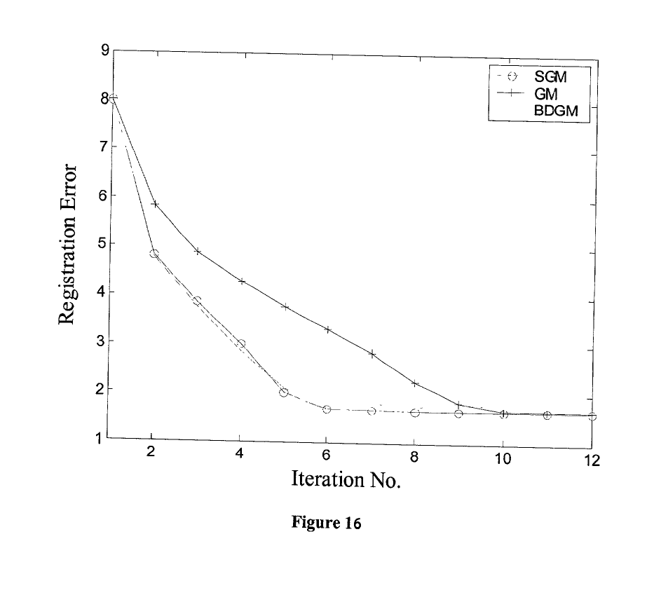

The registration results for the large panoramic motion, shown in FIG. 14, demonstrate the superior convergence of the BDGM (13 iterations) and SGM (17 iterations) compared to the GM (23 iterations). The registration results for the small panoramic motion, shown in FIG. 16, also demonstrate superior convergence of the SGM and BDGM, and show that both the SGM and the BDGM converge almost twice as fast (5 iterations) as the GM (9 iterations).

In summary, the method of the present invention in its two main preferred embodiments includes new formulations and algorithms that enhance the performance of gradient-based image registration methods. These algorithms extend the current state-of-the-art image registration algorithms, and are shown to possess superior convergence range and rate. By analyzing the convergence properties using non-linear optimization algorithms, explicit expressions are derived for the convergence of the GM. The experimental results verify the theoretical analysis. The improved convergence rate of the SGM and BDGM are especially vital for advanced video compression standards such as MPEG-2, 4, H26*, etc, particularly when implemented on low-power mobile devices.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is

1. A method for fast global motion estimation, the global motion defined by a plurality of parameters in which each parameter has an interval, the method comprising:
a. providing a first and a second image,
b. providing an initial estimate of each of two translation parameters, and
c. determining the relative global motion between said first and second images using a symmetric gradient approach in an iterative process starting with said initial estimate of said two translation parameters, whereby said symmetric gradient approach provides the center of each parameter interval and results in improved global motion estimation convergence properties.

2. The method of claim 1, wherein said step of providing an initial estimate of each of two translation parameters includes
i. providing an initial interval for each said translation parameter, and
ii. dividing each said translation parameter initial interval into two equal sub-intervals,
and wherein said step of determining the relative global motion between said first and second images using a symmetric gradient approach includes
i. providing a basic symmetric gradient formulation that includes said sub-intervals,
ii. running in each iteration a point-wise linearization procedure on said basic symmetric gradient formulation, and
iii. deriving in each iteration a symmetric linearization error based on said linearization procedure.

3. The method of claim 2, wherein said substep of providing a basic symmetric gradient formulation further includes using a motion parameters vector P representing the plurality of parameters.

4. The method of claim 3, wherein said step of determining the relative global motion between said first and second images using a symmetric gradient approach further includes: for each iteration:
i. calculating separately for each of said first and second images respective first and second (H^{t}H) matrices,
ii. calculating a combined matrix (H^{t}H)^{SGM} using said first and second matrices,
iii. calculating a vector (H^{t}Iₜ) and
iv. calculating a parameters vector P^{SGM} using said combined matrix and said vector H^{t}Iₜ and using said symmetric linearization error for a continue/stop check.

5. The method of claim 4, wherein said substep of calculating respective first and second (H^{t}H) matrices includes calculating said matrices using respectively equations 59 and 60.

6. The method of claim 4, wherein said combined (H^{t}H)matrix is calculated according to equation 62.

7. The method of claim 1, wherein said global motion is selected from the group consisting from image translation, rotation, affine motion and panoramic motion.

8. The method of claim 1, wherein said improved convergence properties include an improved convergence rate.

9. The method of claim 1, wherein said improved convergence properties include an improved linearization error rate.

10. A method for fast global motion estimation, the global motion defined by a plurality of parameters in which each parameter has an interval, the method comprising:
a. providing a first and a second image,
b. providing an initial estimate of each of two translation parameters, and
c. determining the relative global motion between said first and second images using a bi-directional gradient approach in an iterative process starting with said initial estimate of said two translation parameters, whereby said bi-directional gradient approach provides the optimal location of each parameter interval and results in improved global motion estimation convergence properties.

11. The method of claim 10, wherein said step of providing an initial estimate of each of two translation parameters includes
i. providing an initial interval for each said translation parameter, and
ii. dividing each said translation parameter initial interval into two non-equal equal sub-intervals,
and wherein said step of determining the relative global motion between said first and second images using a bi-directional gradient approach includes
i. providing a basic bi-directional gradient formulation that includes said sub-intervals,
ii. running in each iteration a point-wise linearization procedure on said basic bi-directional gradient formulation, and
iii. deriving in each iteration a bi-directional linearization error based on said linearization procedure.

12. The method of claim 11, wherein said substep of providing a basic bi-directional gradient formulation further includes using a motion parameters vector P representing the plurality of parameters.

13. The method of claim 12, wherein said step of determining the relative global motion between said first and second images using a bi-directional gradient approach further includes: for each iteration:
i. calculating separately for each of said first and second images respective first and second (H^{t}H) matrices,
ii. calculating a combined matrix H^{BDGM} using said first and second matrices,
iii. calculating a vector H^{BDGM}Iₜ, and
iv. calculating a parameters vector P^{BDGM} using said combined matrix and said vector H^{BDGM}Iₜ, and using said symmetric linearization error for a continue/stop check.

14. The method of claim 13, wherein said substep of calculating respective first and second (H^{t}H) matrices includes calculating said matrices using respectively equations 78 and 79.

15. The method of claim 13, wherein said combined (H^{t}H) matrix is calculated according to equation 80.

16. The method of claim 10, wherein said global motion is selected from the group consisting from image translation, rotation, affine motion and panoramic motion.

17. The method of claim 10, wherein said improved convergence properties include an improved convergence rate.

18. The method of claim 10, wherein said improved convergence properties include an improved linearization error rate.
